(19) United States
(12) Patent Application Publication
(10) Pub. No.: US 2026/0341250 A1
(43) Pub. Date: Oct. 29, 2026

(54) IMAGE DISPLAY METHOD AND ELECTRONIC DEVICE

(71) Applicant: Honor Device Co., Ltd., Shenzhen (CN)

(72) Inventors: Qifei Tian, Shenzhen (CN); Kailiang Zhang, Shenzhen (CN)

(21) Appl. No.: 19/700,760

(22) Filed: Jun. 8, 2026

Related U.S. Application Data
(63) Continuation of application No. PCT/CN2024/071468, filed on Jan. 9, 2024.

(51) Int. Cl. G09G 5/12

(52) U.S. Cl. CPC G09G 5/12; G09G 2300/0408; G09G 2310/0245; G09G 2330/021

(57) ABSTRACT

This application provides an image display method and an electronic device, which relate to the field of display technologies. When a display duration of an image on a display screen of the electronic device is prolonged and causes a delay in the displayed image on the display screen, an image display driver of the electronic device increases a frequency at which the display screen outputs a Vsync signal. After receiving display data of a next frame of image, the image display driver writes the display data of the next frame of image to the display screen in response to a Vsync signal at an increased frequency that is fed back by the display screen, to drive the display screen to immediately display the next frame of image.

### CROSS-REFERENCE TO RELATED APPLICATIONS

This application is a continuation of International Application No. PCT/CN 2024/071468, filed on Jan. 9, 2024, which is incorporated herein by reference in its entirety.

### TECHNICAL FIELD

Embodiments of this application relate to the field of display technologies, and in particular, to an image display method and an electronic device.

### BACKGROUND

A vertical synchronization (vertical synchronization, Vsync) technology is to synchronize a frame rate of a graphics processing unit (graphics processing unit, GPU) with a refresh rate of a display screen, to avoid tearing of a displayed image caused by a mismatch between the frame rate of the GPU and the refresh rate of the display screen, in which the display screen starts to refresh and display a next frame of image before completing refresh and display of a previous frame of image.

However, in an actual application of the Vsync technology in an electronic device, based on specifications of a display driver integrated circuit (display driver integrated circuit, DDIC) used by the electronic device and a vertical synchronization response mechanism of the Vsync technology, once a processing overrun occurs in an upper layer of a system of the electronic device during image processing, the DDIC may miss a Vsync signal and consequently, cannot send an image to a display screen (that is, cannot write display data of the image to the display screen). As a result, the display screen may perform a prolonged display of the currently displayed image within at least two consecutive refresh periods. In this case, a user of the electronic device may perceive a noticeable delay in a displayed picture of the device.

Currently, some approaches that improve the software control logic in the upper layer of the system still cannot prevent the DDIC from missing the Vsync signal, making it difficult to effectively resolve the problem that the user perceives the delay in the displayed picture of the device caused by a long-time display of a first image on the display screen.

### SUMMARY

Embodiments of this application provide an image display method and an electronic device, to reduce the duration for which a display screen performs a prolonged display of an image, thereby making a delay in a displayed picture of the device less perceptible to a user.

To achieve the foregoing objective, embodiments of this application adopt the following technical solution: When a display screen of an electronic device performs a prolonged display of an image, an image display driver of the electronic device immediately increases a frequency of outputting a Vsync signal, thereby delivering the image for display (writing display data of the image to the display screen) in response to the Vsync signal at the increased frequency. In other words, in this application, when the display screen performs a prolonged display of the image, the image display driver delivers the image for display in response to the Vsync signal at the increased frequency, which can effectively reduce the duration for which the display screen performs a prolonged display of the image, thereby making a delay in the displayed picture of the device less perceptible to the user.

According to a first aspect, this application provides an image display method. The method is applied to an electronic device. The electronic device generates a first vertical synchronization Vsync signal at a first time, and the display screen of the electronic device starts to display a first image in response to the first Vsync signal. The electronic device generates a second Vsync signal at a second time after the first time, and the display screen starts to display a second image in response to the second Vsync signal. The electronic device generates a third Vsync signal at a third time in response to a second display duration for which the display screen displays the second image being greater than a first display duration for which the display screen displays the first image.

In this application, the first Vsync signal generated by the electronic device at the first time corresponds to a first Vsync periodicity, and the first Vsync periodicity corresponds to the first display duration of the first image. The second Vsync signal generated by the electronic device at the second time corresponds to a second Vsync periodicity, and the second Vsync periodicity is equal to the first Vsync periodicity. The third Vsync signal generated by the electronic device at the third time corresponds to a third Vsync periodicity, and the third Vsync periodicity is less than the first Vsync periodicity. It may be understood that, the third Vsync signal is the foregoing Vsync signal at the increased frequency.

In this application, when the display screen of the electronic device performs a prolonged display of the second image, the frequency of outputting the Vsync signal is increased, so that the image display driver of the electronic device can write, in response to the Vsync signal at the increased frequency that is fed back by the display screen, display data of a next frame of image of the second image to the display screen within a short prolonged display of the second image on the display screen, to drive the display screen to immediately display the next frame of image. This can effectively improve performance of immediately delivering an image for display in the image display process on the electronic device. Compared with the conventional solution, the image display driver of the electronic device delivers the next frame of image of the second image for display in response to the Vsync signal at the increased frequency, which can effectively reduce the duration for which the display screen performs a prolonged display of the second image, thereby making a delay in the displayed picture of the device less perceptible to the user.

In a possible implementation of the first aspect, the second image is a next frame of image of the first image.

In a possible implementation of the first aspect, the second display duration is less than twice the first display duration.

In this application, when the second display duration of the second image on the display screen is greater than the first display duration but less than twice the first display duration, the frequency of outputting the Vsync signal is increased, so that when the second display duration is less than twice the first display duration, the image display driver can drive the display screen to start to display the next frame of image of the second image. Therefore, the display screen does not perform a long-time display of the second image for two consecutive first Vsync periodicities, thereby avoiding a delay in the displayed picture of the device that occurs in the conventional solution.

In a possible implementation of the first aspect, the display screen displays a third image in a next frame of the second image, in response to the third Vsync signal.

In this application, when receiving display data of the third image in the next frame of the second image, the image display driver of the electronic device writes the display data of the third image to the display screen in response to the third Vsync signal triggered by the display screen at the third time, to drive the display screen to refresh and display the third frame of image after a short prolonged display of the second image. In this way, the display screen does not need to refresh and display the third image after performing the prolonged display of the second image for at least two consecutive Vsync periodicities, which can effectively reduce the duration for which the display screen performs a prolonged display of the second image, thereby making a delay in the displayed picture of the device less perceptible to the user.

In a possible implementation of the first aspect, a third display duration for which the display screen displays the third image is less than the first display duration corresponding to the first Vsync periodicity.

In a possible implementation of the first aspect, the third display duration for which the display screen displays the third image is the same as the first display duration corresponding to the first Vsync periodicity.

In this application, the display duration for which the display screen displays the third image is made to be the same as the first display duration corresponding to the first Vsync periodicity, so that stability of displaying each frame of image can be ensured in a process in which the display screen performs image refresh and display.

In a possible implementation of the first aspect, the electronic device generates a fourth Vsync signal at a fourth time after the second time and before the third time.

In a possible implementation of the first aspect, the display screen continues to performs a prolonged display of the second image in response to the fourth Vsync signal.

In a possible implementation of the first aspect, when the display screen generates the first Vsync signal at the first time by using a frequency of 120 Hz, the first Vsync periodicity corresponding to the first Vsync signal is approximately 8.3( 1/120≈8.3) ms. Then, when a frequency at which the display screen outputs a Vsync signal is increased to 360 Hz, the third Vsync periodicity corresponding to the third Vsync signal output by the display screen at the third time is approximately 2.8 ( 1/360≈2.8) ms.

In a possible implementation of the first aspect, when the first Vsync periodicity is approximately 8.3 ms, and the third Vsync periodicity is approximately 2.8 ms, the first display duration corresponding to the first Vsync periodicity is approximately 8.3 ms, and the second display duration for which the display screen displays the second image is approximately 8.3 ms+2.8 ms=11.1 ms.

In a possible implementation of the first aspect, the electronic device generates a fifth Vsync signal at a fifth time after the third time. The fifth Vsync signal corresponds to a fifth Vsync periodicity, and the fifth Vsync periodicity is equal to the first Vsync periodicity.

In a possible implementation of the first aspect, a display duration of a fourth image is greater than a preset time interval; and the fourth image is an image displayed in the previous frame of the fifth time, the preset time interval is obtained by subtracting a duration consumed for reducing a frequency of outputting a Vsync signal from a time interval between the fifth time and a sixth time, and the sixth time is a time at which the fourth image is written to the display screen.

In this application, after the display screen starts to display the third image, in response to the display duration of the fourth image being greater than the duration obtained by subtracting the duration consumed for reducing the frequency of outputting the Vsync signal from the time interval between the fifth time and the sixth time, the electronic device reduces the frequency of outputting the Vsync signal. Then, at the fifth time after the third time, the electronic device generates the fifth Vsync signal having a Vsync periodicity equal to the first Vsync periodicity. The fourth image is the third image itself or a frame of image after the third image. The sixth time is a time at which the fourth image is written to the display screen. In other words, when the fourth image is the third image itself, the sixth time is the third time at which the display screen starts to display the third image in response to the third Vsync signal (in this case, the third image is written to the display screen and starts to be displayed on the display screen). When the fourth image is a frame of image after the third image, the sixth time is a time at which the display screen starts to display the frame of image after the third image (in this case, the frame of image after the third image is written to the display screen and starts to be displayed on the display screen). The time interval between the fifth time and the sixth time is the first display duration corresponding to the first Vsync periodicity.

For example, as shown in FIG. 20, an example in which the fourth image is the third image itself and the sixth time is the third time is used. After the display screen starts to display the third image (an image 2) at the third time (t5), the electronic device calculates the third display duration of the image 2 in real time. When the third display duration is greater than the duration obtained by subtracting the duration consumed for reducing the frequency of outputting the Vsync signal (where the consumed duration is a duration between a time shown by a vertical dashed line on the right side of the figure and t6) from the time interval 8.3 ms between the fifth time (t6) and t5, the electronic device reduces the frequency of outputting the Vsync signal at the time shown by the vertical dashed line on the right side of the figure. In this way, at the time t6, the electronic device generates the fifth Vsync signal (a Vsync signal 6) having a fifth Vsync periodicity of 8.3 ms (which is equal to the first Vsync periodicity).

In this application, reducing the frequency of outputting the Vsync signal can avoid power consumption waste of the device caused by the display screen continuously outputting the Vsync signal (the third Vsync signal) at the increased frequency, thereby reducing power consumption of the device.

In a possible implementation of the first aspect, the fifth time is N 8.3 ms apart from the third time, where N is a positive integer greater than or equal to 1.

In a possible implementation of the first aspect, after the display screen of the electronic device displays the third image, the image display driver of the electronic device determines whether display data of a next frame of image of the third image has been received within the third display duration for which the display screen displays the third image. In addition, when it is determined that the display data of the next frame of image of the third image has been received within the third display duration for which the display screen displays the third image, the image display driver reduces the frequency at which the display screen outputs the Vsync signal.

In this application, after it is further determined that the display of the third image on the display screen has become stable, the frequency of outputting the Vsync signal is reduced. This can avoid power consumption waste of the device caused by the display screen continuously outputting the Vsync signal at the increased frequency, thereby reducing power consumption of the device.

In another possible implementation of the first aspect, after the display screen of the electronic device displays the third image, the electronic device may further detect whether the image display driver has received display data of an N^{th} frame of image after the third image within a display duration for which the display screen displays an (N−1)^{th} frame of image after the third image. N is a positive integer greater than 1.

In this way, when it is detected that the image display driver has received the display data of the N^{th} frame of image after the third image within the display duration for which the display screen displays the (N−1)^{th} frame of image after the third image, the image display driver reduces the frequency at which the display screen outputs the Vsync signal.

In this application, after it is determined that the display of the (N−1)^{th} frame of image after the third image on the display screen has become stable, the frequency of outputting the Vsync signal is reduced. This can also avoid power consumption waste of the device caused by the display screen continuously outputting the Vsync signal at the increased frequency after the display of the image has become stable.

Moreover, after the display of the (N−1)^{th} frame of image after the third image on the display screen has become stable, the frequency of outputting the Vsync signal is reduced, further avoiding frequently increasing and reducing the frequency of outputting the Vsync signal, thereby further reducing power consumption required for the device to frequently adjust the frequency of outputting the Vsync signal.

In another possible implementation of the first aspect, the electronic device further includes the image display driver. The image display driver calculates, in response to the display screen displaying the second image, the second display duration for which the display screen displays the second image. In addition, the image display driver compares the second display duration with the first display duration. When the second display duration is greater than the first display duration, the image display driver sends a control instruction to the display screen in response to the second display duration being greater than the first display duration. The display screen increases a frequency of outputting a Vsync signal in response to the control instruction, and generates the third Vsync signal at an increased frequency at the third time after the second time.

For example, a delay detection module is configured in the image display driver of the electronic device, and whether the second display duration is greater than the first display duration is detected by using the delay detection module, to improve the frequency of outputting the Vsync signal when the delay detection module detects that the second display duration is greater than the first display duration. In this way, because the image display driver is located in a kernel layer of an entire system of the electronic device, whether the second display duration is greater than the first display duration due to an upper layer of a system (for example, an application layer, an application framework layer, or a hardware abstraction layer) or due to the kernel layer itself, it can be detected by using the delay detection module newly added in the kernel layer. That is, comprehensiveness and accuracy in detecting whether the second display duration is greater than the first display duration are improved.

In another possible implementation of the first aspect, when the image display driver of the electronic device detects whether the second display duration is greater than the first display duration by using the delay detection module, the electronic device may first detect whether the image display driver responds to the second Vsync signal. Then, when it is detected that the image display driver responds to the second Vsync signal, to determine that the electronic device displays the second image and is not in a state in which the display screen is delayed in displaying the first image, the image display driver detects, by using the delay detection module, whether the second display duration for which the display screen displays the second image is greater than the first display duration.

In this application, before the delay detection module detects whether the second display duration is greater than the first display duration, whether the image display driver responds to the second Vsync signal is first detected. When it is detected that the image display driver responds to the second Vsync signal, to determine that the electronic device currently displays the second image and is not in a state in which the display screen is delayed in displaying the first image, the delay detection module then detects whether the second display duration is greater than the first display duration. This can ensure that the frequency of outputting the Vsync signal is increased only when the electronic device enters a delayed image display state (where the display screen performs a prolonged display of an image) from a non-delayed image display state, to specifically reduce a degree of a delay on the displayed picture of the device caused by the long-time display of the image.

In another possible implementation of the first aspect, when increasing the frequency of outputting the Vsync signal, the image display driver of the electronic device may control the display screen to increase the frequency of outputting the Vsync signal to M times an original frequency. M is a positive integer greater than 1. The original frequency is a frequency at which the display screen feeds back the Vsync signal to the image display driver and other software and hardware modules in an upper layer of the system of the electronic device when displaying images at a current refresh rate. For example, when the display screen supports a base frequency of 360 Hz, the original frequency may be 60 Hz, 90 Hz, or 120 Hz.

In another possible implementation of the first aspect, when the image display driver of the electronic device controls the display screen to increase the frequency of outputting the Vsync signal to M times the original frequency, before the display screen outputs an i^{th} Vsync signal at an increased frequency, the image display driver may receive the display data of the third image sent by the upper layer of the system. i is a positive integer, and i is less than M. Based on this, the image display driver writes, in response to the i^{th} Vsync signal at the increased frequency, the display data of the third image to the display screen to drive the display screen to display the third image.

In this application, before the display screen outputs the i^{th} Vsync signal at the increased frequency, the image display driver of the electronic device receives the display data of the third image, and writes, in response to the i^{th} Vsync signal at the increased frequency, the display data of the third image to the display screen to drive the display screen to display the third image. This can ensure that the image display driver of the electronic device delivers, in response to the Vsync signal at the increased frequency that is triggered by the display screen, the third image in a next frame of the second image for display within a short prolonged display of the second image on the display screen, instead of displaying the second image for at least two consecutive Vsync periodicities as in the conventional solution to cause a long prolonged display of the second image before delivering the third image for display in response to the Vsync signal triggered at the original frequency by the display screen. That is, stability of reducing the duration for which the display screen performs the prolonged display of the second image is ensured.

In another possible implementation of the first aspect, after the image display driver of the electronic device starts to write the display data of the third image to the display screen to drive the display screen to start to display the third image, in order to prevent the image display driver from directly responding to a new Vsync signal at an increased frequency and delivering the next frame of image of the third image for display in advance, which may cause the display screen to display the third image within a short time, the image display driver further stops responding, within a third display duration for which the display screen displays the third image, to any Vsync signal at the increased frequency that is triggered by the display screen, to reject to write display data of the next frame of image of the third image to the display screen within the third display duration.

Then, only when the third display duration is greater than a difference between the first display duration and the third Vsync periodicity, the image display driver resumes responding to the Vsync signal at the increased frequency that is triggered by the display screen, to write the display data of the next frame of image of the third image to the display screen in response to the Vsync signal at the increased frequency after determining that the third display duration reaches the first display duration.

In this application, by not responding to the Vsync signal at the increased frequency within the third display duration, it is possible to avoid a phenomenon that the display screen only briefly displays the third image due to the image display driver delivering the next frame of image of the third image for display in advance in a process in which the display screen displays the third image. Therefore, stability of the electronic device in displaying the third image and its subsequent images is further improved.

According to a second aspect, this application provides an electronic device. The electronic device has a function of implementing the method in the first aspect. The function may be implemented by using hardware or may be implemented by hardware by executing corresponding software. The hardware or software includes one or more modules corresponding to the foregoing function.

According to a third aspect, this application provides an electronic device, including: a processor and a memory. The memory is configured to store computer program code. The computer program code includes computer-executable instructions. When the electronic device is run, the processor executes the computer-executable instructions, to cause the electronic device to perform the method in the first aspect.

According to a fourth aspect, this application provides an electronic device, including: a processor. The processor is configured to: be coupled to a memory, read instructions from the memory, and perform the method in the first aspect based on the instructions.

According to a fifth aspect, this application provides a computer-readable storage medium. The computer-readable storage medium stores computer instructions. The computer instructions, when run on the electronic device, cause the electronic device to perform the method in the first aspect.

According to a sixth aspect, this application provides a computer program product including instructions. The computer program product, when run on a computer, cause the computer to perform the method in the first aspect.

According to a seventh aspect, an apparatus (which may be, for example, a display system) is provided. The apparatus includes a processor, configured to support an electronic device in implementing the function involved in the first aspect. In a possible design, the apparatus further includes a memory. The memory is configured to store program instructions and data that are necessary for the electronic device.

For the technical effects brought by any one of the designs in the second to seventh aspects, reference may be made to the technical effects brought by different implementations in the first aspect, and details are not described herein again.

### BRIEF DESCRIPTION OF THE DRAWINGS

FIG. 1 is a schematic diagram of a hardware structure of an electronic device according to an embodiment of this application;

FIG. 2 is a schematic diagram of a system architecture of an electronic device in the conventional technologies;

FIG. 3 is a schematic diagram of a principle of layer drawing, rendering, compositing, and image frame display in an electronic device in the conventional technologies;

FIG. 4 is another schematic diagram of a principle of layer drawing, rendering, compositing, and image frame display in an electronic device in the conventional technologies;

FIG. 5 is a schematic diagram of a system architecture of an electronic device according to an embodiment of this application;

FIG. 6 is a schematic diagram of a principle of layer drawing, rendering, compositing, and image frame display in an electronic device according to an embodiment of this application;

FIG. 7 is another schematic diagram of a principle of layer drawing, rendering, compositing, and image frame display in an electronic device according to an embodiment of this application;

FIG. 8 is a schematic flowchart 1 of an image display method according to an embodiment of this application;

FIG. 9 is a waveform diagram of by a display screen outputting a Vsync signal by using a 120 Hz-TE standard frequency synchronization scheme according to an embodiment of this application;

FIG. 10 is a waveform diagram of a display screen outputting a Vsync signal by using a 360 Hz-TE high frequency synchronization scheme according to an embodiment of this application;

FIG. 11 is a schematic diagram of durations for which a display screen displays images in a case involved in an embodiment of this application;

FIG. 12 is a schematic diagram of durations for which a display screen displays images in another case involved in an embodiment of this application;

FIG. 13 is a schematic diagram of a principle of an electronic device delivering images for display in response to a Vsync signal at an increased frequency in a case involved in an embodiment of this application;

FIG. 14 is a schematic diagram of a principle of an electronic device delivering images for display in response to a Vsync signal at an increased frequency in another case involved in an embodiment of this application;

FIG. 15 is a schematic diagram of a principle of an electronic device delivering images for display in response to a Vsync signal at an increased frequency in still another case involved in an embodiment of this application;

FIG. 16 is a schematic diagram of a system architecture and a data signal flow of an electronic device involved in an embodiment of this application;

FIG. 17 is a schematic diagram of control logic of image display by an electronic device involved in an embodiment of this application;

FIG. 18 is a schematic flowchart 2 of an image display method according to an embodiment of this application;

FIG. 19 is a schematic diagram of a principle of an electronic device extending an image display duration involved in an embodiment of this application;

FIG. 20 is a schematic diagram of a principle of an electronic device reducing a frequency of outputting a Vsync signal in a case involved in an embodiment of this application; and

FIG. 21 is a schematic diagram of a principle of an electronic device reducing a frequency of outputting a Vsync signal in another case involved in an embodiment of this application.

### DETAILED DESCRIPTION OF THE ILLUSTRATIVE EMBODIMENTS

Embodiments of this application provide an image display method. The method is applicable to an electronic device including a display screen. In a case of a prolonged display of an image on the display screen, a frequency of a vertical synchronization signal output by the display screen is increased, so that an image display driver of the electronic device delivers an image for display in response to the vertical synchronization signal at the higher frequency. This can effectively reduce the duration for which the display screen performs the prolonged display of the image, making a delay in the displayed picture of the device less perceptible to a user.

It should be noted that the electronic device may be an electronic device having a display screen such as a mobile phone, a tablet computer, a desktop/laptop/handheld computer, a notebook computer, an ultra-mobile personal computer (ultra-mobile personal computer, UMPC), a netbook, a personal digital assistant (personal digital assistant, PDA), or an augmented reality (augmented reality, AR)/virtual reality (virtual reality, VR) device. A specific form of the electronic device is not specifically limited in this embodiment of this application.

Implementations of embodiments of this application are described below in detail with reference to the accompanying drawings.

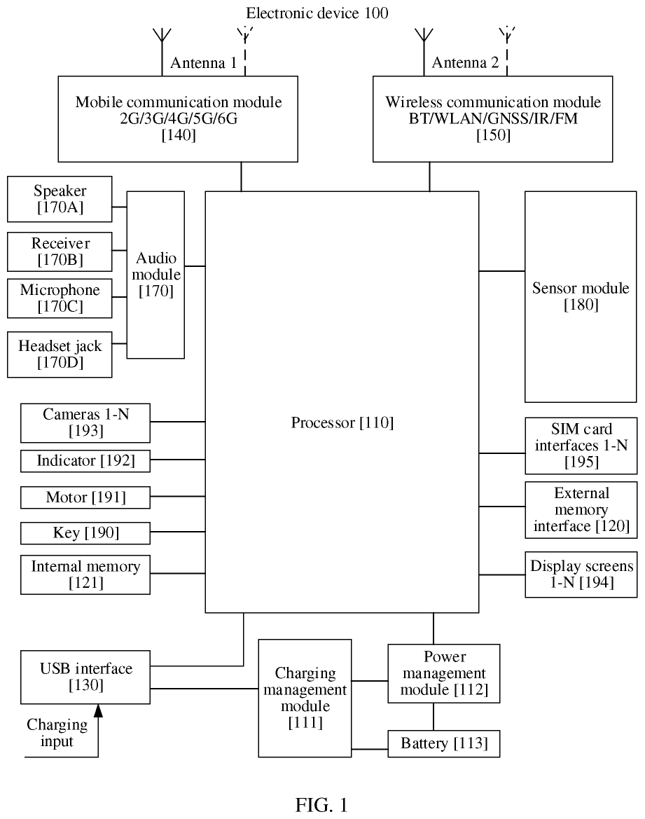

Refer to FIG. 1. FIG. 1 is a schematic diagram of a structure of an electronic device 100 according to an embodiment of this application. As shown in FIG. 1, the electronic device 100 may include: a processor 110, an external memory interface 120, an internal memory 121, a universal serial bus (universal serial bus, USB) interface 130, a charging management module 111, a power management unit 112, a battery 113, an antenna 1, an antenna 2, a mobile communication module 140, a wireless communication module 150, an audio module 170, a speaker 170A, a receiver 170B, a microphone 170C, a headset jack 170D, a sensor module 180, a key 190, a motor 191, an indicator 192, a camera 193, a display screen 194, a subscriber identity module (subscriber identification module, SIM) card interface 195, and the like.

It may be understood that the structure illustrated in an embodiment of the present invention does not constitute a specific limitation on the electronic device 100. In some other embodiments of this application, the electronic device 100 may include more or fewer components than those shown in the figure, some components may be combined, some components may be split, or different component arrangements may be used. The illustrated components may be implemented in hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, and/or a neural-network processing unit (neural-network processing unit, NPU). Different processing units may be separate devices, or may be integrated into one or more processors. The controller may be a nerve center and a command center of the electronic device 100. The controller may generate an operation control signal based on instruction operation code and a time sequence signal, and control obtaining and executing of instructions.

A memory may be further disposed in the processor 110, and is configured to store instructions and data. In some embodiments, the memory in the processor 110 is a cache. The memory may store instructions or data recently used or cyclically used by the processor 110. If the processor 110 needs to use the instructions or the data again, the processor 110 may directly invoke the instructions or the data from the memory. This avoids repeated access, and reduces waiting time of the processor 110, so that system efficiency is improved.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

It may be understood that an interface connection relationship between modules illustrated in this embodiment of the present invention is merely an example for description, and does not constitute a limitation on the structure of the electronic device 100. In some other embodiments of this application, the electronic device 100 may alternatively use an interface connection manner different from that in the foregoing embodiment, or use a combination of a plurality of the interface connection manners.

The charging management module 111 is configured to receive charging input from a charger. When charging the battery 113, the charging management module 111 may further supply power to the electronic device through the power management module 112. A wireless communication function of the electronic device 100 may be implemented by using the antenna 1, the antenna 2, the mobile communication module 140, the wireless communication module 150, the modem processor, the baseband processor, and the like.

The antenna 1 and the antenna 2 are configured to transmit and receive an electromagnetic wave signal. Each antenna in the electronic device 100 may be configured to cover a single or a plurality of communication bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 140 may provide 2G/3G/4G/5G/6G or other wireless communication solutions applied to the electronic device 100. The modem processor may include a modulator and a demodulator. The wireless communication module 150 may provide a solution to wireless communication applied to the electronic device 100, including a wireless local area network (wireless local area network, WLAN) (such as a wireless fidelity (wireless fidelity, Wi-Fi) network), Bluetooth (Bluetooth, BT), a global navigation satellite system (global navigation satellite system, GNSS), frequency modulation (frequency modulation, FM), near field communication (near field communication, NFC), an infrared (infrared, IR) technology, and the like.

The electronic device 100 implements a display function by using the GPU, the display screen 194, the application processor, and the like. The GPU is a microprocessor for image processing, and is connected to the display screen 194 and the application processor. The GPU is configured to perform mathematical and geometric calculation for image rendering. The processor 110 may include one or more GPUs that perform program instructions to generate or change display information.

The display screen (or referred to as a screen) 194 is configured to display an image, a video, and the like. The display screen 194 includes a display panel. The display panel may include, but is not limited to, a liquid crystal display (liquid crystal display, LCD), an organic light-emitting diode (organic light-emitting diode, OLED), an active-matrix organic light-emitting diode or active-matrix organic light-emitting diode (active-matrix organic light-emitting diode, AMOLED), a flexible light-emitting diode (flex light-emitting diode, FLED), a mini light-emitting diode (mini organic light-emitting diode, Mini LED), a micro organic light-emitting diode (micro organic light-emitting diode, MicroLed), a quantum dot light-emitting diode (quantum dot light-emitting diode, QLED), or the like. In some embodiments, the electronic device 100 may include 1 or N display screens 194, where N is a positive integer greater than 1.

The electronic device 100 may implement a photographing function by using the ISP, the camera 193, the video encoder and decoder, the GPU, the display screen 194, the application processor, and the like.

The external memory interface 120 may be configured to be connected to an external memory card, for example, a Micro SD card, to expand a storage capability of the electronic device 200.

The internal memory 121 may be configured to store computer-executable program code, and the computer-executable program code includes instructions.

The processor 110 runs the instructions stored in the internal memory 121, to perform various function applications and data processing of the electronic device 100. The internal memory 121 may include a program storage area and a data storage area. The program storage area may store an operating system, an application required by at least one function (for example, a sound playback function or an image playback function), and the like. The data storage area may store data (such as audio data and a phone book) created in a use process of the electronic device 100. In addition, the internal memory 121 may include a high-speed random access memory, and may also include a non-volatile memory, for example, at least one magnetic disk storage device, flash memory device, universal flash storage (universal flash storage, UFS), or the like.

The electronic device 100 may implement an audio function, for example, music playing and recording, by using the audio module 170, the speaker 170A, the receiver 170B, the microphone 170C, the headset jack 170D, the application processor, and the like.

The key 190 includes a power key, a volume key, or the like. The indicator 192 may be an indicator light.

The sensor module 180 may include a folding angle detection sensor, a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

It should be noted that in embodiments of this application, a display screen of an electronic device to which the image display method provided in embodiments of this application is applied is of a screen type supporting Source IC (Source IC) refresh interrupt. Source IC refresh interrupt means that a Source IC of a display screen, when in a non-refresh state, may be interrupted by a driver at any time (referred to as Source refresh interrupt), to re-enter a refresh state and start to work. Work performed by the Source IC in the refresh state may be: refreshing display data of an image to cause a display screen to start to display the image, or switching a refresh rate of a display screen in response to a frame switching instruction.

For example, the display screen of the electronic device may be a display screen that uses a low temperature polysilicon oxide (low temperature polysilicon oxide, LTPO) transistor, thereby supporting Source refresh interrupt based on a characteristic of a low leakage current of LTPO. However, the display screen of the electronic device generally cannot be a display screen that uses a low temperature poly-silicon (low temperature poly-silicon, LTPS) transistor. As a leakage current of a transistor increases, even if the display screen still supports Source refresh interrupt, its overall display effect is seriously affected. Therefore, due to the characteristic of severe leakage current of LTPS, a display screen using LTPS usually does not support a function of Source refresh interrupt. Therefore, it may be understood that, provided that the display screen of the electronic device uses a transistor having the characteristic of low leakage current, the display screen can support source refresh interrupt.

Based on different design requirements in actual applications, the transistor used by the display of the electronic device may certainly be another type other than LTPO. However, regardless of the specific type of the transistor used by the display screen, and regardless of whether the display screen can support source refresh interrupt due to the characteristic of low leakage current of the transistor, any display screen of the electronic device that is of a screen type supporting Source refresh interrupt shall fall within the protection scope of the image display method provided in embodiments of this application.

In this embodiment of this application, a base frequency supported by the display screen of the electronic device may be 60 hertz (Hz), 70 Hz, 75 Hz, 80 Hz, 90 Hz, 120 Hz, 360 Hz, or the like. A refresh rate at which the display screen performs image display (referred to as an image refresh rate or a display frame rate) is less than or equal to the base frequency supported by the display screen. In addition, the image refresh rate supported by the display screen is usually less than or equal to 120 Hz. For example, the image refresh rate of the display screen may be usually configured to 60 hertz (Hz), 70 Hz, 75 Hz, 80 Hz, 90 Hz, or 120 Hz.

When the display screen supports an image refresh rate of 120 Hz, the display screen may improve the image refresh rate from 60 Hz, 70 Hz, 75 Hz, 80 Hz, or 90 Hz to 120 Hz, or reduce the image refresh rate from 120 Hz to 90 Hz, 80 Hz, 75 Hz, 70 Hz, or 60 Hz. In this embodiment of this application, the image refresh rate of the electronic device is the image refresh rate currently used by the display screen of the electronic device. Therefore, in some feasible embodiments of this application, the image refresh rate of the electronic device or the image refresh rate of the display screen of the electronic device may also be referred to as a current refresh rate.

It should be noted that in this embodiment of this application, a Vsync signal is a periodic discrete signal involved in a process in which the Vsync technology is applied to the electronic device. In other words, at an interval of a Vsync periodicity (which may also be referred to as a refresh period, a refresh duration, or the like), a Vsync signal is triggered by a hardware driver.

It should be noted that in this embodiment of this application, the Vsync signal is used for triggering hardware to refresh and display an image frame. The Vsync signal may be triggered and generated by the display screen and fed back to an APP, the modem processor, the GPU, the ISP, the controller, and the like. Therefore, the Vsync signal may also be considered as a type of tearing effect (tearing effect, TE) signal fed back from the display screen 194 to the processor 110.

In this embodiment of this application, when the display screen supports a base frequency of 360 Hz, the display screen may adaptively switch a frequency of outputting a Vsync signal to 60 Hz, 90 Hz, 120 Hz, or 360 Hz based on control of an image display driver in the electronic device, thereby triggering and outputting Vsync signals of different Vsync periodicities at different times.

The Vsync signal may have different names in different systems or architectures. For example, in some systems or architectures, the Vsync signal may be specifically VSYNC_APP, VSYNC_SF, or VSYNC_HW. However, regardless of the name of the Vsync signal, any synchronization signal with a similar function that conforms to the technical idea of the method provided in embodiments of this application shall fall within the protection scope of this application. In addition, in different systems or architectures, the definition of the Vsync signal may also vary. However, regardless of how the Vsync signal is defined, any synchronization signal with a similar function that conforms to the technical idea of the method provided in embodiments of this application shall fall within the protection scope of this application.

It should be noted that a software system of the electronic device may use a layered architecture, an event-driven architecture, a microkernel architecture, a microservices architecture, or a cloud architecture. For ease of understanding, that the image display method provided in embodiments of this application is applied to the electronic device is described in detail by using an Android system with a layered architecture as an example in this embodiment of this application.

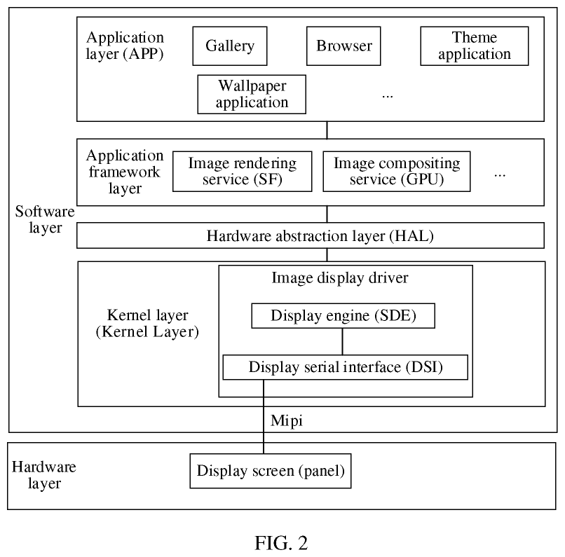

The following describes, with reference to FIG. 2, a software and hardware processing procedure of an electronic device of an Android system in this process by using an example in which the electronic device sends (or writes) an image to a display screen for display in response to a Vsync signal.

As shown in FIG. 2, a software and hardware architecture of the electronic device uses a layered design. A software layer includes an application layer (Application Layer, APP Layer), an application framework layer (Application Framework Layer, FWK Layer), a hardware abstraction layer (Hardware Abstraction Layer, HAL), and a kernel layer (Kernel Layer). A hardware layer includes a display screen (panel). The application layer may include various types of applications running in the electronic device, such as a gallery, a browser, a theme application, and a wallpaper application. The application framework layer mainly involves a graphics processing service, such as an image rendering service (surface flinger, SF) for rendering a to-be-displayed image provided by an application, and an image compositing service (GPU) for compositing a plurality of layers of a to-be-displayed image. The kernel layer mainly includes an image display driver. The image display driver is mainly configured to send, to a display screen, a to-be-displayed image that is processed and delivered by an upper layer of a system (which is another system layer above the kernel layer in which the image display driver is located, such as the application layer, the application framework layer, and the hardware abstraction layer). The hardware layer mainly includes the display screen (panel) for refreshing and displaying a to-be-displayed image based on invoking of the image display driver.

In the system framework of the electronic device shown in FIG. 2, image drawing and display require cooperation among the system layers based on the Vsync signal output by the display screen. In other words, an application APP such as a gallery, a browser, a theme application, or a wallpaper application in the application layer performs, when receiving a Vsync signal output by the display screen, image drawing in response to the Vsync signal. When a next Vsync signal output by the display screen arrives, the APP delivers a drawn image to the application framework layer in response to the Vsync signal. In this way, the SF and the GPU in the application framework layer respectively perform image rendering and layer compositing on the drawn image, to obtain display data of the to-be-displayed image, and the display data of the to-be-displayed image is transferred to the image display driver in the kernel layer through the hardware abstraction layer. Further, when the display screen outputs a new Vsync signal again, the image display driver invokes, in response to the new Vsync signal, a display serial interface (display serial interface, DSI) by using a smart display engine (smart display engine, SDE), to write the display data of the to-be-displayed image to a DDIC of the display screen, and the DDIC of the display screen may store, into a buffer (buffer), image data sent by a software side for display, so as to control the display panel to complete image refresh and display (display) by scanning (or reading) the display data in the buffer.

In the foregoing processing procedure of image display by the electronic device, because the system layers of the software layer of the electronic device implement final image display through cooperation based on the Vsync signal output by the display screen, monitoring and response to the Vsync signal by the layers are crucial. However, in an actual application of the Vsync technology in an electronic device, based on DDIC specifications used in the electronic device and a vertical synchronization response mechanism of the Vsync technology, once an processing overrun occurs in an upper layer of a system of the electronic device during image processing, the image display driver may miss a Vsync signal and cannot send the image to the display screen, and needs to send the image in response at least after waiting for a next Vsync signal to be received. In this way, the display screen performs a prolonged display of the same frame of image within at least two consecutive refresh periods. In this way, a user of the electronic device may perceive a visually noticeable delay in the displayed picture of the device.

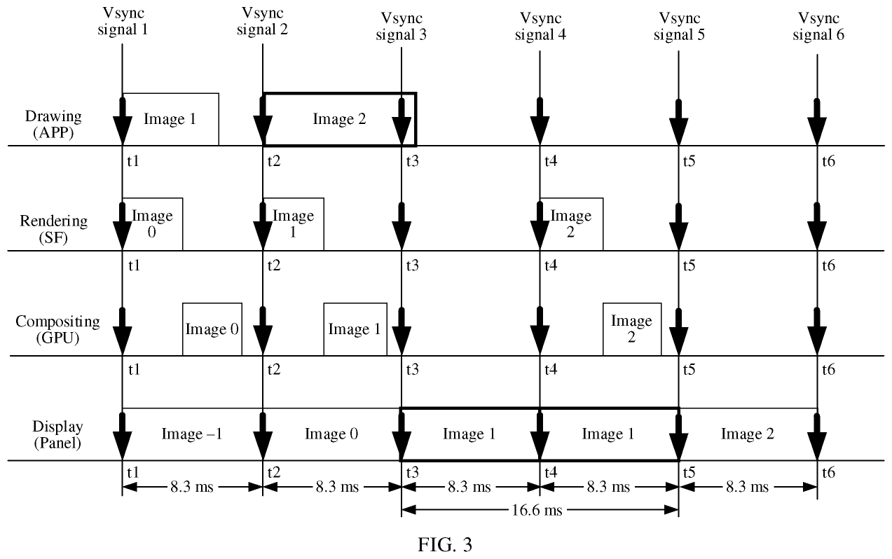

As shown in FIG. 3, the DDIC of the display screen of the electronic device supports an image refresh rate of 120 Hz. Therefore, when the DDIC refreshes and outputs a vertical synchronization signal at a frequency of 120 Hz, a Vsync periodicity of outputting the vertical synchronization signal is approximately 8.3 ms, so that a display duration for which the display screen displays an image is also approximately 8.3 ms. In this way, at a time t1, a Vsync signal 1 output by the display screen arrives. The APP in the application layer of the electronic device starts to draw an image 1 in response to a Vsync signal 1. The SF of the application framework layer of the electronic device also renders, in response to the Vsync signal 1 by using a rendering service render server (which may also be referred to as a render thread), an image 0 previously delivered by the APP. The image 0 is further sent downward to the GPU after the SF completes rendering on the image 0, so that after receiving the image 0, the GPU immediately starts to perform layer compositing on the image 0. In this case, the display screen also starts to display an image −1 in a previous frame of the image 0 for a period of 8.3 ms until a time t2 arrives.

At the time t2, a Vsync signal 2 output by the display screen arrives. The APP in the application layer of the electronic device starts to draw an image 2 in response to a Vsync signal 2. The SF also renders, in response to the Vsync signal 2, the image 1 delivered by the APP at the time t2. The image 1 is further sent downward to the GPU after the SF completes rendering on the image 1, so that after receiving the image 1, the GPU starts to perform layer compositing on the image 1. In this case, the GPU synchronously delivers display data of the image 1 to the image display driver in the kernel layer of the system of the electronic device after completing compositing on the image 1 (that is, a time at which the GPU completes image compositing indicates that the image display driver has received the composited display data of the image 1). Therefore, after the GPU completes the compositing on the image 0 and delivers the image 0 to the image display driver before the time t2, the image display driver writes display data of the image 0 to the display screen at the time t2 in response to the Vsync signal 2, so that the display screen refreshes and displays the image 0 at the time t2 until a time t3.

At the time t3, a Vsync signal 3 output by the display screen arrives. However, if the electronic device is in a high-load scenario between the time t2 and the time t3, causing the App in the application layer not to have completed drawing on the image 2, both the SF and the GPU do not perform any image processing action until a next Vsync signal arrives because the SF and the GPU have not received the image 2 that was supposed to be delivered by the APP at the time t3. In this case, because the GPU completes the compositing on the image 1 before the time t3, and delivers the display data of the image 1 to the image display driver, the image display driver writes the display data of the image 1 to the display screen at the time t3 in response to the Vsync signal 3. The display screen starts to refresh and display the image 1 at the time t3 until a time t4.

At the time t4, a Vsync signal 4 output by the display screen arrives. In this case, if the electronic device has no new image display requirement, the APP does not respond to the Vsync signal 4 to perform image drawing in this case. However, because the SF receives the image 2 drawn and delivered previously by the APP at the time t4, the SF still starts to render the image 2 in response to the Vsync signal 4. In addition, after the SF completes the rendering of the image 2, the GPU further performs layer compositing on the image 2 delivered by the SF, and delivers display data of the image 2 to the image display driver. In this case, the image display driver does not receive display data of any image at the time t4, and consequently, misses the Vsync signal 4 and does not write display data of an image to the display screen. In this way, the display screen continues to display the image 1 at the time t4 until a time t5.

At the time t5, a Vsync signal 5 output by the display screen arrives. The image display driver writes, in response to the Vsync signal 5, the display data of the image 2 received previously to the display screen. Therefore, the display screen refreshes and displays the image 2 at the time t5 until a time t6. At the time t6, the APP has completed original image display requirements of the electronic device before the time t4, and therefore, does not draw a new image. In addition, the electronic device does not generate a new image display requirement from the time t3 to the time t6, so that the display screen does not continue image refresh and display after completing the display of the image 2 at the time t6. In this case, the display screen enters a sleep or screen-off state.

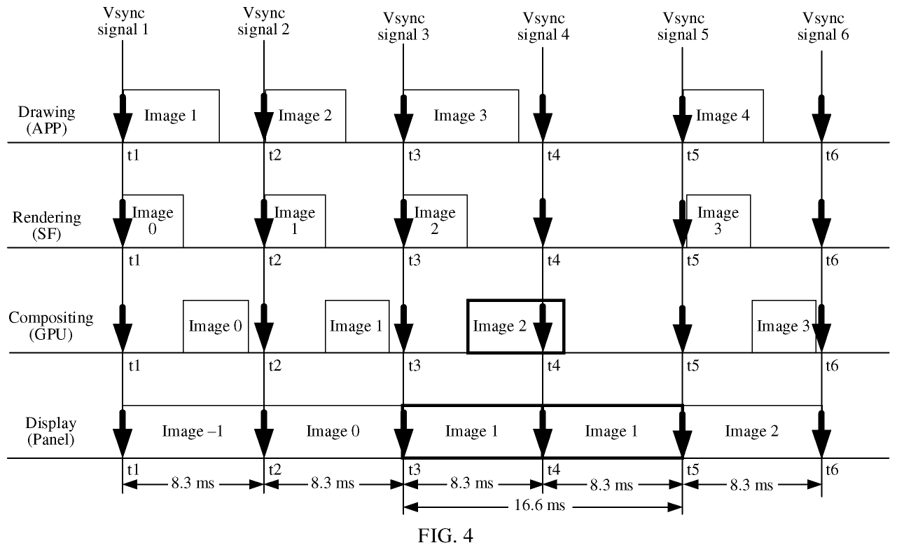

As shown in FIG. 4, the display screen of the electronic device still uses a refresh rate of 120 Hz, outputs a Vsync signal with a Vsync periodicity of 8.3 ms, and also displays an image for a display duration of 8.3 ms. In this case, at the time t4, the Vsync signal 4 output by the display screen arrives. However, if the electronic device is in a high-load scenario between the time t3 and the time t4, causing the GPU not to have completed compositing on the image 2, the image display driver in the kernel layer of the electronic device does not receive the display data of the image 2 before the time t4, and consequently, misses the Vsync signal 4 and does not write display data of any image to the display screen. As a result, the display screen continues to display, at the time t4 until the time t5, the image 1 that starts to be displayed at the time t3.

In summary, in some high-load scenarios, the electronic device may experience an overrun in the application layer where the APP draws an image, in the application framework layer where the SF renders an image (not shown in the figures), or in the application framework layer where the GPU composites an image. Consequently, the image display driver in the kernel layer misses a Vsync signal for sending an image to the display screen. As a result, the display screen needs to display the currently displayed image for two consecutive periods (16.6 ms). That is, in this case, the display screen exhibits a direct drop of a current refresh rate from 120 Hz to 60 Hz. For the user, the direct drop of the current refresh rate of the display screen from 120 Hz to 60 Hz may cause a visually noticeable delay in the displayed image.

It should be noted that in this embodiment of this application, the high-load scenario of the electronic device may be a scenario in which available system resources allocated to the APP, the SF, or the GPU are reduced because a large number of threads are simultaneously started in the electronic device. It should be understood that in different systems or architectures, the definition of the high-load scenario in the electronic device may also vary. However, regardless of how the high-load scenario is defined, provided that the scenario affects the response of the system to the vertical synchronization signal for image drawing, rendering, or compositing, causing the display screen to perform a prolonged display of the image, to make the user perceive a delay in the displayed picture of the device, the scenario conforms to the technical idea of the method provided in embodiments of this application and shall fall within the protection scope of this application.

For the above situation, even though there are currently some approaches attempting to improve the above user experience, these approaches rely on modifications to software control logic of the upper layer of the system of the electronic device, such as changing algorithm processing logic for image drawing, rendering, or compositing in the upper layer of the system to minimize an intermediate consumed time for image processing. However, regardless of how the software control logic in the upper layer of the system is adjusted, it cannot fundamentally avoid the electronic device times out in response to the Vsync signal or directly missing the Vsync signal caused by performance limitations of hardware used in the electronic device. In other words, currently, improvements are made only to the software control logic in the upper layer of the system of the electronic device, making it difficult to effectively resolve a problem that the user perceives a delay in the displayed picture of the device due to a long prolonged display of an image on the display screen.

In order to reduce a degree of a delay perceived by the user in the displayed picture of the device due to a prolonged display of an image on the display screen, and effectively improve visual experience of the user on the displayed image, this application provides an image display method, to reduce the duration for which the display screen performs the prolonged display of the image, thereby making a delay in the displayed picture of the device less perceptible to the user.

It should be noted that the method provided in embodiments of this application may be considered as an independent improvement relative to the foregoing solution of adjusting the software control logic in the upper layer of the system of the electronic device, or may be considered as a further optimization and supplement to the solution of adjusting the software control logic. In other words, the image display method provided in embodiments of this application implements an independent improvement at the software control level of the system of the electronic device, and the method provided in embodiments of this application further creatively makes improvements at the hardware level of the system, to further reduce, by combining the improvements at both the software and hardware levels of the system, the duration for which the display screen performs a prolonged display of an image, which can greatly reduce a degree of a delay in the displayed picture of the device, thereby making the delay in the displayed picture of the device less perceptible to the user.

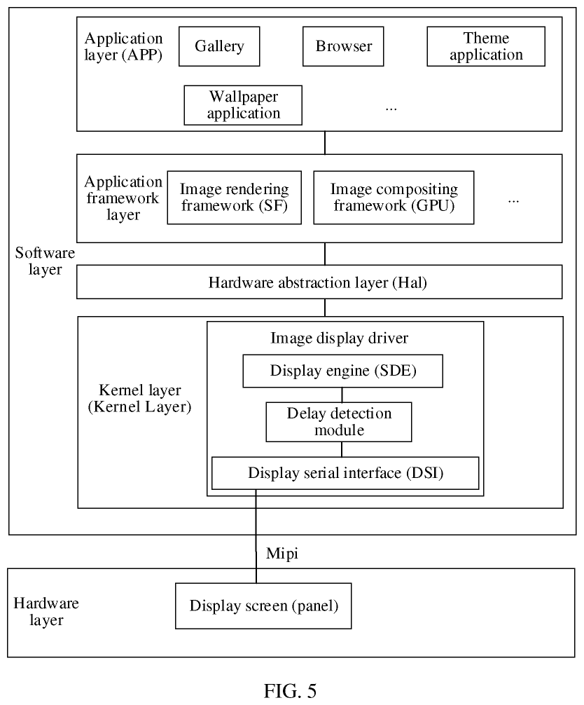

In a feasible implementation of embodiments of this application, as shown in FIG. 5, in the method provided in embodiments of this application, a delay detection module may be added to the kernel layer of the system of the electronic device, to detect, in an image display process of the electronic device, whether a duration for which the display screen of the electronic device displays the image is greater than an image display duration corresponding to a current refresh rate used by the display screen. Based on this, when the delay detection module detects that the display screen performs a prolonged display of the image, an image display driver of the electronic device immediately increases a frequency at which the display screen outputs a Vsync signal, so that display data of a next frame of image is written to the display screen within a short time in response to a Vsync signal at an increased frequency, to drive the display screen to display the next frame of image. That is, the method provided in embodiments of this application enables the display screen to quickly display a next frame of image in a case of a slight delay in the displayed image, rather than requiring the display screen to display the image for an image display duration corresponding to at least two consecutive Vsync periodicities before displaying the next frame of image, as in the conventional solution. This can effectively reduce the duration for which the display screen performs the prolonged display of the image, to greatly reduce a degree of a delay in the displayed picture of the device, making the delay in the displayed picture of the device less perceptible to the user.

In the method provided in embodiments of this application, the delay detection module is configured in the image display driver in the kernel layer of the system of the electronic device. In this way, whether the prolonged display of the image on the display screen is caused by the kernel layer at which the delay detection module is located or by the application layer, the application framework layer, or the hardware abstraction layer of the system can be detected by the delay detection module. This can also improve comprehensiveness of detecting whether the display of the image on the display screen is prolonged, and improve accuracy of enabling the image display driver to deliver a next frame of image for display in real time by increasing a frequency of outputting a Vsync signal.

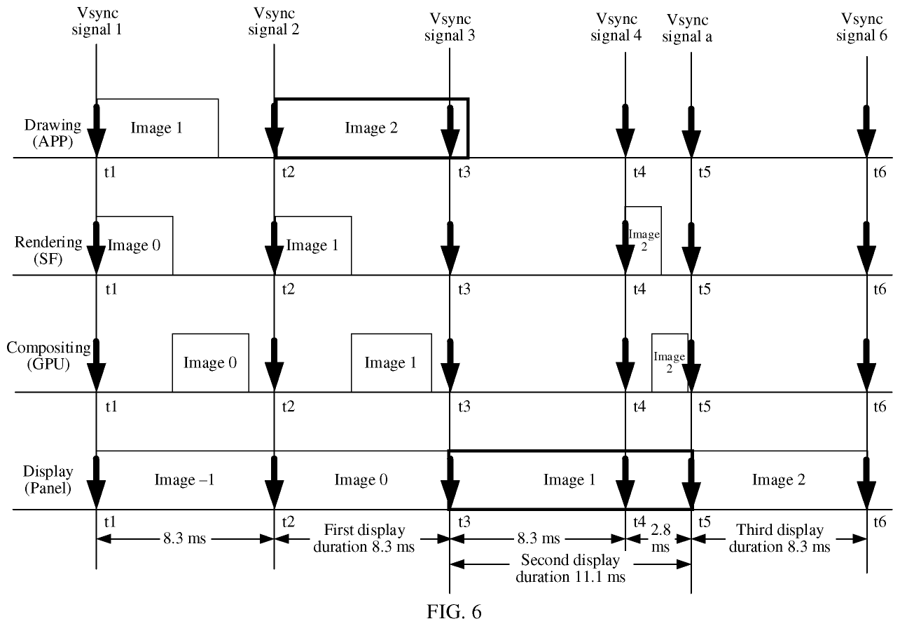

A feasible specific implementation of the image display method provided in embodiments of this application is described below with reference to FIG. 6.

As shown in FIG. 6, in a process in which the display screen (supporting a base frequency of 360 Hz) of the electronic device performs image refresh and display at a current refresh rate of 120 Hz, if, at a time t3, a duration for which by an APP configured to draw an image at a system application layer draws a to-be-displayed image 2 exceeds a Vsync periodicity of 8.3 ms corresponding to the current refresh rate of 120 Hz, the APP does not respond to a Vsync signal 3 to deliver display data of the image 2 to the SF at the application frame layer at the time t3. Consequently, the image display driver misses the Vsync signal 3 and cannot send an image to the display screen at the time t3, resulting in a prolonged display of an image 1 on the display screen. However, in the image display method provided in embodiments of this application, when a newly added hardware module, that is, the delay detection module, in the kernel layer of the system of the electronic device, monitors and recognizes a prolonged display (exceeding 8.3 ms) of the image 1 on the display screen at a time t4, the image display driver of the electronic device increases the frequency at which the display screen outputs the Vsync signal to 360 Hz. Therefore, the display screen outputs a Vsync signal a (corresponding to a Vsync periodicity of 2.8 ms) at an increased frequency at a time t5, and the image display driver in the kernel layer of the system, which is configured to drive the display screen, can write, after receiving the Vsync signal a, display data of the image 2 received before the time t5 to the display screen in response to the Vsync signal a. In this way, when the display duration of the image 1 at the time t5 is prolonged by only approximately 2.8 ms, the display screen starts to display the image 2.

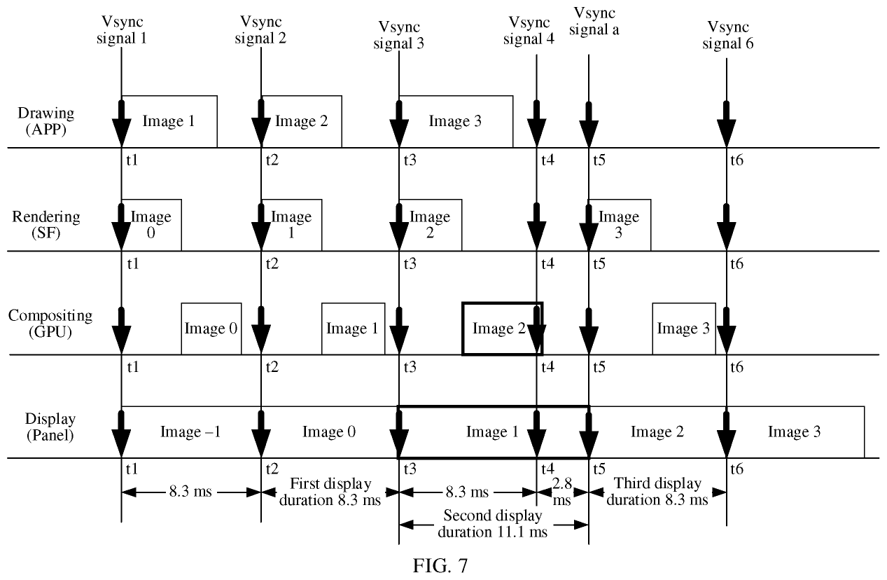

As shown in FIG. 7, in a process in which the display screen (supporting a base frequency of 360 Hz) of the electronic device performs image refresh and display at a current refresh rate of 120 Hz, if the GPU at the application frame layer of the system performs compositing on the image 2 for more than 8.3 ms, the GPU delivers the display data of the image 2 to the image display driver in the kernel layer only after the time t4. Consequently, the image display driver misses the Vsync signal 4 and cannot send the image to the display screen at the time t4, resulting in a prolonged display of the image 1 on the display screen. For such a phenomenon, the image display method provided in embodiments of this application increases the frequency at which the display screen outputs the Vsync signal to 360 Hz when the electronic device detects, by using the delay detection module, a prolonged display of the image 1 on the display screen. Therefore, the display screen may output the Vsync signal a (corresponding to a Vsync periodicity of 2.8 ms) at an increased frequency at the time t5, and the image display driver writes to the display screen, in response to the Vsync signal a at the time t5, the display data of the image 2 that has been composited by the GPU and delivered to the image display driver before the time t5, so that the display screen starts to display the image 2 when the display duration of the image 1 is prolonged only for approximately 2.8 ms.

Compared with the conventional solution, in the image display method provided in embodiments of this application, when the newly added delay detection module finds a prolonged display of an image on the display screen due to missed Vsync signals (also referred to as dropped frames) at various layers of the system of the electronic device, the frequency at which the display screen outputs the Vsync signal is immediately increased, so that the image display driver immediately delivers the image for display based on the Vsync signal at the increased frequency. In this way, the display screen may not display, as in the conventional solution, display an image within at least two consecutive Vsync periodicities (for example, one Vsync periodicity is 8.3 ms, and two Vsync periodicities are 16.6 ms), which may result in a long (for example, 8.3 ms) prolonged display of the image before displaying a next frame of image written by the image display driver. Instead, the display screen can perform an extremely short (for example, 2.8 ms) prolonged display of the image before displaying the next frame of image in response to the image display driver. For the user, the extremely short prolonged display of an image on the display screen is almost visually imperceptible. That is, in this application, when the display screen of the electronic device performs a prolonged display of an image, the frequency of outputting the Vsync signal can be increased to cause the image display driver to quickly delivers a next frame of image for display, which can effectively reduce the duration for which the display screen performs the prolonged display of the image, thereby making a delay in the displayed picture of the device less perceptible to the user.

In addition, in this embodiment of this application, it may be found by comparing FIG. 3 with FIG. 6 or comparing FIG. 4 with FIG. 7 that, compared with the conventional solution, the image display method provided in embodiments of this application enables the electronic device to display more image frames during image display within the same unit duration in response to the Vsync signal. That is, the method provided in embodiments of this application can further effectively improve an average frame rate of image display by the electronic device in response to the Vsync signal. In addition, a larger number of times the system of the electronic device misses the Vsync signal, causing the display screen to perform a prolonged display of an image indicates a larger number of image frames displayed in response within the same unit time in the method provided in embodiments of this application, thereby making the improvement in the average frame rate of image display by the electronic device more significant and effective.

Based on the above overall overview of the image display method provided in embodiments of this application, specific embodiments of the image display method provided in embodiments of this application are described in sequence below.

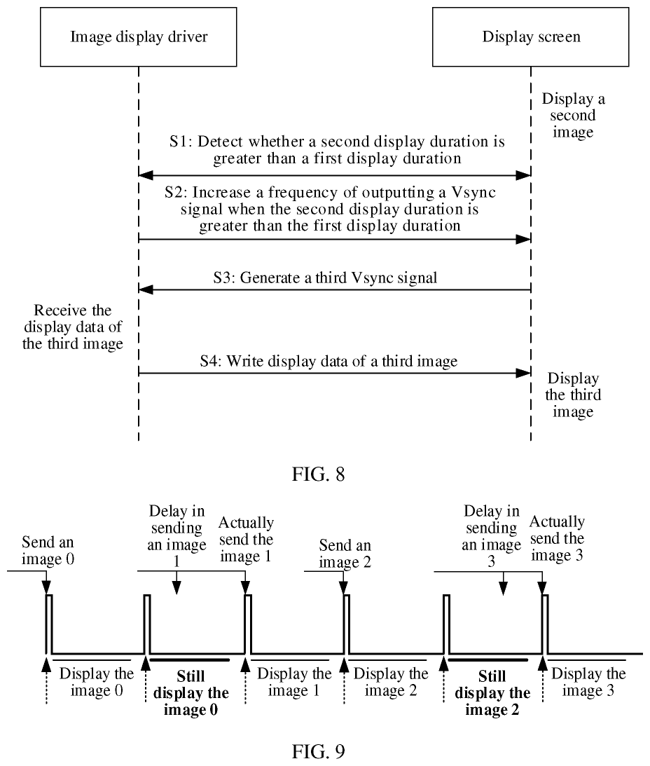

Refer to FIG. 8. FIG. 8 is a schematic flowchart of an image display method according to an embodiment of this application in a specific implementation. It should be understood that, although FIG. 8 shows an execution sequence of some method steps, the image display method provided in this embodiment of this application may certainly use an execution sequence of method steps different from that shown in the figure based on different design requirements in actual applications. In other words, an order of the method steps shown in FIG. 8 does not constitute a limitation to an execution logic order of the image display method provided in this embodiment of this application. Any proper change based on the order of the method steps shown in FIG. 8 shall fall within the protection scope of the image display method provided in this embodiment of this application.

In a feasible embodiment of the image display method provided in this embodiment of this application, when the image display method is performed by an electronic device, the electronic device generates a first Vsync signal at a first time, and a display screen of the electronic device starts to display a first image in response to the first Vsync signal. The electronic device generates a second Vsync signal at a second time after the first time. The display screen starts to display a second image in response to the second Vsync signal. The electronic device generates a third Vsync signal at a third time after the second time in response to a second display duration for which the display screen displays the second image being greater than a first display duration for which the display screen displays the first image.

It should be noted that in this embodiment of this application, the first Vsync signal generated by the electronic device at the first time corresponds to a first Vsync periodicity, and the first Vsync periodicity corresponds to the first display duration of the first image. That is, the first Vsync periodicity is equal to the first display duration. The second Vsync signal generated by the electronic device at the second time corresponds to a second Vsync periodicity, and the second Vsync periodicity is equal to the first Vsync periodicity. The third Vsync signal generated by the electronic device at the third time corresponds to a third Vsync periodicity, and the third Vsync periodicity is less than the first Vsync periodicity.

In this embodiment of this application, a smaller Vsync periodicity indicates a higher frequency of outputting a Vsync signal. That the electronic device generates the third Vsync signal at the third time in response to the second display duration being greater than the first display duration may be that: the electronic device controls, by using an image display driver of the electronic device when the second display duration is greater than the first display duration, the display screen to increase a frequency of triggering the Vsync signal, so that the display screen outputs the third Vsync signal at an increased frequency at the third time.

In this embodiment of this application, the third Vsync signal is generated at the third time, so that the display screen may start to display a next frame of image of the second image after an extremely short prolonged display of the second image.

In a feasible embodiment, for a specific process in which the electronic device controls, by using the image display driver, the display screen to increase the frequency of triggering the Vsync signal, and the electronic device generates the third Vsync signal at the third time, refer to S1 to S3 shown in FIG. 8.

S1: Detect whether the second display duration is greater than the first display duration.

In this embodiment of this application, the image display driver of the electronic device calculates in real time, after the display screen displays the second image in response to the second Vsync signal at the second time, the second display duration for which the display screen displays the second image, and detects whether the second display duration is greater than the first display duration for which the display screen displays the first image.

It should be noted that in this embodiment of this application, the second image displayed on the display screen is a next frame of image of the first image displayed on the display screen.

For example, when the display screen performs image refresh and display at a current refresh rate of 60 Hz, and trigger the first Vsync signal at the first time by using the frequency of 60 Hz as the frequency of triggering the Vsync signal, the first Vsync periodicity corresponding to the first Vsync signal is approximately 1/60≈16.6 ms. That is, the display screen triggers a first Vsync signal at an interval of 16.6 ms. In this case, the first display duration corresponding to the first Vsync periodicity is also approximately 16.6 ms, that is, the display screen refreshes and displays one frame of image at an interval of approximately 16.6 ms. In this way, because the second Vsync periodicity is equal to the first Vsync periodicity, after the display screen displays the second image in response to the second Vsync signal at the second time, the second display duration for which the display screen continuously displays the second image is also approximately 16.6 ms. In this way, if after the display screen displays the second image, the image display driver of the electronic device calculates the second display duration in real time, and detects that the second display duration is greater than 16.6 ms, it may be considered that the second display duration is greater than the first display duration.

S2: Increase a frequency of outputting the Vsync signal when the second display duration is greater than the first display duration.

In this embodiment of this application, in a process in which the display screen displays the second image, when detecting that the second display duration of the second image is greater than the first display duration, the image display driver of the electronic device controls the display screen to increase the frequency of outputting the Vsync signal.

For example, in a process in which the display screen displays the second image at the current refresh rate of 60 Hz as the frequency of outputting the Vsync signal, the image display driver of the electronic device calculates in real time the second display duration for which the display screen displays the second image, and detects that the second display duration is greater than the first display duration of 16.6 ms, it is determined that a delay occurs in the current display of the second image on the display screen. Therefore, the image display driver immediately delivers a control instruction to the display screen, to control the display screen to increase the currently used frequency of 60 Hz of outputting the Vsync signal.

S3: Generate the third Vsync signal.

In this embodiment of this application, after the image display driver of the electronic device controls the display screen to increase the frequency of outputting the Vsync signal, the display screen outputs the third Vsync signal at an increased frequency to the image display driver and other software and hardware modules at the third time after the second time.

It should be noted that in this embodiment of this application, a higher frequency of outputting the Vsync signal indicates a smaller Vsync periodicity. Therefore, after the display screen increases the frequency of outputting the Vsync signal, the third Vsync periodicity corresponding to the third Vsync signal triggered at the third time is less than the first Vsync periodicity and is also less than the second Vsync periodicity (when the display screen outputs the first Vsync signal at the first time and outputs the second Vsync signal at the second time, the frequency of outputting the Vsync signal has not been increased).

For example, after the electronic device controls display to increase the currently used frequency of 60 Hz of outputting the Vsync signal to 360 Hz, the display screen outputs, based on a Vsync periodicity of 1/360≈2.8 ms corresponding to the increased frequency of 360 Hz, the 1^{st} third Vsync signal at the increased output frequency after the frequency of outputting the Vsync signal is increased for approximately 2.8 ms. In this case, the third Vsync periodicity corresponding to the third Vsync signal is approximately 2.8 ms and less than the first Vsync periodicity that is approximately 16.6 ms.

In a feasible embodiment, for a specific process in which the display screen displays a next frame of image of the second image in response to the third Vsync signal, refer to S4 shown in FIG. 8.

S4: Write display data of a third image.

It should be noted that in this embodiment of this application, the third image is the next frame of image of the second image.

In this embodiment of this application, in response to the electronic device generating the third Vsync signal at the third time, the display screen displays the third image. In other words, after receiving the display data of the third image sent by the upper layer of the system, the image display driver of the electronic device writes the display data of the third image to the display screen in response to the third Vsync signal at an increased frequency that is output by the display screen at the third time, so that the display screen displays the third image at the third time.

For example, assuming that the display screen of the electronic device supports a base frequency of 360 Hz, in a process in which the display screen displays an image by using an image display duration of 8.3 ms corresponding to the current refresh rate of 120 Hz, the display screen uses the frequency of 120 Hz as the frequency of outputting the Vsync signal. After the display screen starts to display the second image in response to the second Vsync signal at the second time, the image display driver of the electronic device continuously detects whether the second display duration for which the display screen displays the second image is greater than the first display duration of 8.3 ms (a Vsync periodicity corresponding to a frequency of 120 Hz is approximately 8.3 ms). In this way, when detecting that the second display duration is greater than 8.3 ms, the image display driver determines that a delay occurs in the current display of the second image on the display screen, to control the display screen to enable a preset 360 Hz-TE high-frequency synchronization scheme, to control the display screen to increase the frequency of outputting the Vsync signal to 360 Hz. In this way, the display screen outputs, at the third time, the third Vsync signal at the increased frequency based on a Vsync periodicity of 1/360≈2.8 ms corresponding to the frequency of 360 Hz. After receiving the third Vsync signal, the image display driver writes to the display screen, in response to the third Vsync signal, the display data of the third image sent by the upper layer of the system before the third time. In this way, the display screen starts to refresh and display the third image at the third time. In this case, the display screen performs a prolonged display of the second image only for approximately 2.8 ms.

In some other feasible embodiments, in addition to receiving the display data of the third image before receiving the third Vsync signal, the image display driver of the electronic device may further receive the display data of the third image delivered by the upper layer of the system in response to the third Vsync signal while receiving the third Vsync signal, and write the display data of the third image to the display screen in response to the third Vsync signal. For example, due to a relatively small data volume of the display data of the third image, when a consumed time for processing the display data of the third image by the upper layer of the system and transmitting the display data of the third image between software and hardware modules is short, a situation in which the image display driver has not received the display data before completing responding to the Vsync signal does not occur. In this way, after receiving the third Vsync signal, the image display driver may receive the display data of the third image, which has a relatively small data volume, and write the display data of the third image to the display screen while responding to the third Vsync signal.

It should be noted that in this embodiment of this application, the 360 Hz-TE high-frequency synchronization scheme may be a Vsync signal output control scheme that is added to the display screen in advance, for the display screen to switch the frequency of outputting the Vsync signal based on requirements. It should be understood that based on different design requirements in actual applications, certainly, other Vsync signal output control schemes of the same type but with different frequencies, such as a 60 Hz-TE low-frequency synchronization scheme and a 120 Hz-TE standard frequency synchronization scheme, may alternatively be added to the display screen in advance.

When responding to enabling a synchronization scheme of a specific frequency, the display screen outputs a Vsync signal based on a Vsync periodicity corresponding to the frequency. For example, when responding to enabling the 360 Hz-TE high-frequency synchronization scheme, the display screen outputs a Vsync signal at an interval of 2.8 ms based on a Vsync periodicity of 2.8 ms corresponding to the frequency of 360 Hz. When the display screen responds to enabling the 120 Hz-TE standard frequency synchronization scheme, the display screen outputs a Vsync signal at an interval of 8.3 ms based on a Vsync periodicity of 8.3 ms corresponding to the frequency of 120 Hz. When the display screen responds to enabling the 60 Hz-TE standard frequency synchronization scheme, the display screen outputs a Vsync signal at an interval of 16.6 ms based on a Vsync periodicity of 16.6 ms corresponding to the frequency of 60 Hz.

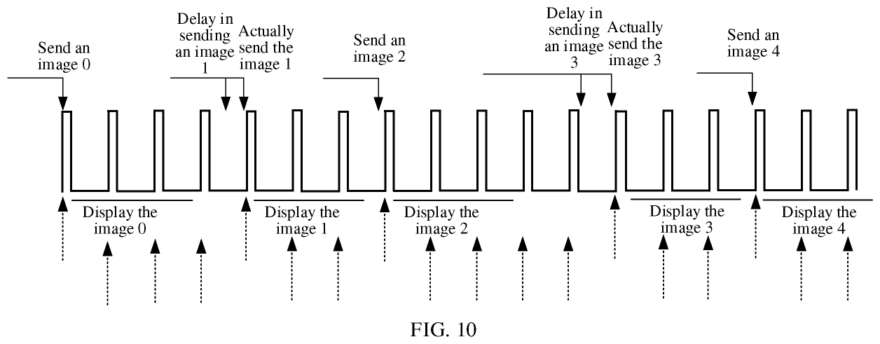

In this embodiment of this application, when the display screen of the electronic device uses 120 Hz as the current refresh rate to perform image refresh and display, the display screen may use the 120 Hz-TE standard frequency synchronization scheme by default to output a Vsync signal at an original frequency of 120 Hz. In this way, by comparing a waveform diagram of a display screen refreshing and outputting a Vsync signal by using a 120 Hz-TE standard frequency synchronization scheme shown in FIG. 9 with a waveform diagram of a display screen refreshing and outputting a Vsync signal by using a 360 Hz-TE standard frequency synchronization scheme shown in FIG. 10, it can be seen that in a process in which the display screen outputs the Vsync signal at a frequency of 120 Hz (where all dashed arrows in FIG. 9 and FIG. 10 indicate times at which the display screen outputs the Vsync signal), if the image display driver misses a Vsync signal, resulting in a delay in sending an image 1 to the display screen, the display screen displays an image 0 in a previous frame of the image 1 within at least two consecutive Vsync periodicities. If the image display driver misses a Vsync signal, resulting in a delay in sending an image 3 to the display screen, the display screen also displays the image 2 in a previous frame of the image 3 within at least two consecutive Vsync periodicities. However, if the display screen outputs the Vsync signal at the frequency of 360 Hz, when the image display driver misses a Vsync signal (which is a Vsync signal at a high frequency in this case), resulting in a delay in sending the image 1 to the display screen, the image display driver only needs to perform a prolonged display of the image 0 for a short Vsync periodicity, and then sends an image to the display screen in response to a next Vsync signal at a high frequency, to start to display the image 1. However, even if the image display driver misses two consecutive high-frequency Vsync signals and does not send the image 3 to the display screen, the display screen only needs to perform a prolonged display of the image 2 for two short Vsync periodicities. Even two short Vsync periodicities (2.8 ms+2.8 ms=5.4 ms) are shorter than one Vsync periodicity (8.3 ms) of outputting a Vsync signal at the frequency of 120 Hz.

Compared with the conventional solution, in the image display method provided in this embodiment of this application, when the display screen performs a prolonged display of an image, the frequency at which the display screen outputs the Vsync signal is increased, so that the image display driver immediately delivers an image for display based on the Vsync signal at the increased frequency. In this way, the display screen may display a next frame of image in response to the image display driver only after an extremely short prolonged display of the image. For the user, a delay in the displayed picture of the device is almost visually imperceptible. In other words, the method provided in this embodiment of this application can effectively reduce the duration for which the display screen performs a prolonged display of an image, thereby making a delay in the displayed picture of the device less perceptible to the user.

In a feasible embodiment, the second display duration for which the display screen displays the second image is less than twice the first display duration.

In this embodiment of this application, as long as the display screen starts to display the third image in response to the third Vsync signal corresponding to a smaller Vsync periodicity when the second display duration is greater than the first display duration but less than twice the first display duration, the display screen does not perform a long-time display of the second image for two consecutive first Vsync periodicities, thereby avoiding a delay in the displayed picture of the device that occurs in the conventional solution.

In this way, in addition to controlling the display screen to increase the frequency of outputting the Vsync signal as soon as it detects that the second display duration is greater than the first display duration, the image display driver of the electronic device may alternatively choose to control the display screen to increase the frequency of outputting the Vsync signal at any time when the second display duration is greater than the first display duration but less than twice the first display duration. In this case, the image display driver writes the display data of the third image to the display screen in response to the third Vsync signal at the increased frequency that is output by the display screen, so that the display screen displays the third image when a duration of a prolonged display of the second image is not less than the first display duration.

In a feasible embodiment, a third display duration for which the display screen displays the third image is less than the first display duration.

In this embodiment of this application, the display screen displays the third image in response to the third Vsync signal at the increased frequency when the display of the second image is prolonged (where the second display duration is greater than the first display duration). Therefore, if the electronic device generates a new Vsync signal by using a Vsync periodicity corresponding to the third Vsync signal, and the image display driver of the electronic device also receives display data of a next frame of image of the third image before (or simultaneously with) the generation of the new Vsync signal by the electronic device, the image display driver writes the display data of the next frame of image of the third image to the display screen in response to the new Vsync signal. That is, the display screen starts to refresh and display the next frame of image of the third image in response to the new Vsync signal. In this way, the third display duration for which the display screen displays the third image (approximately from the third time to a time at which the electronic device generates the new Vsync signal) is less than the first display duration corresponding to the first Vsync periodicity.

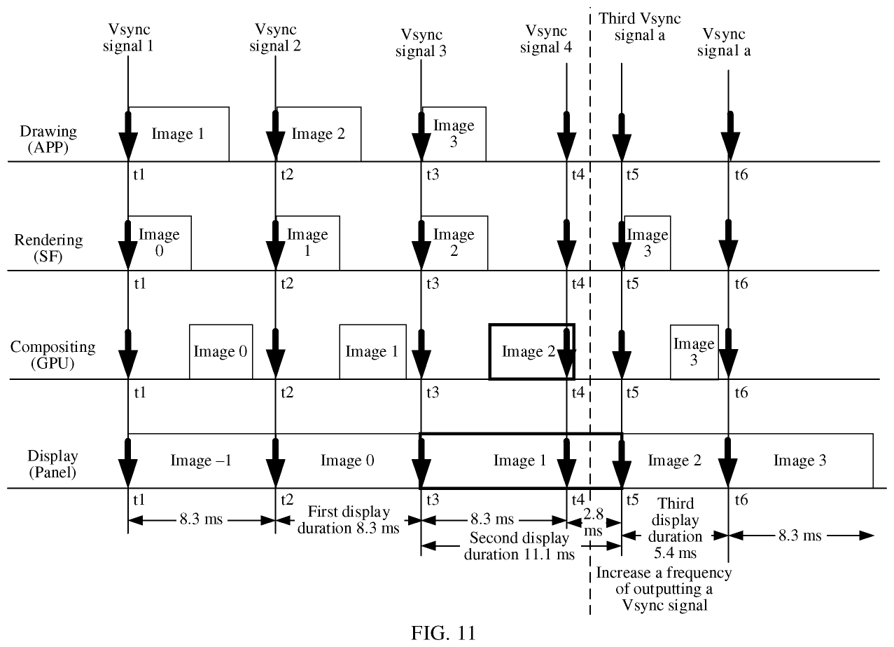

For example, as shown in FIG. 11, when the image display driver controls, after a time t4 (a time shown by a vertical dashed line in the figure), the display screen to increase the frequency of outputting the Vsync signal from the original frequency of 120 Hz to 360 Hz, the display screen displays the third image (an image 2) at the third time (t5) in response to a third Vsync signal a. Then, if the display screen still triggers a new Vsync signal a at 360 Hz, the display screen starts to refresh and display an image 3 in a next frame of the image 2 at a time t6 in response to the new Vsync signal. In this case, the third display duration for which the display screen displays the third image is only approximately 5.4 ms, and is less than the first display duration 8.3 ms of the first image (the image 0).

In another feasible embodiment, the third display duration for which the display screen displays the third image may be the same as the first display duration.

In this embodiment of this application, the display screen starts to display the third image in response to the third Vsync signal at the increased frequency when the display of the second image is prolonged. Therefore, if the electronic device generates a new Vsync signal by using a Vsync periodicity corresponding to the third Vsync signal, and the image display driver of the electronic device receives display data of a next frame of image of the third image before (or simultaneously with) the generation of an (M+1)^{th} new Vsync signal by the electronic device, the image display driver writes the display data of the next frame of image of the third image to the display screen in response to the new Vsync signal. That is, the display screen refreshes and displays the next frame of image of the third image in response to the new Vsync signal. In this way, the display duration for which the display screen displays the third image is equal to the first display duration corresponding to the first Vsync periodicity.

It should be noted that in this embodiment of this application, M is the multiple of an increased frequency at which the display screen outputs the Vsync signal relative to the frequency at which the display screen outputs the Vsync signal before the increase, where M is greater than 1.

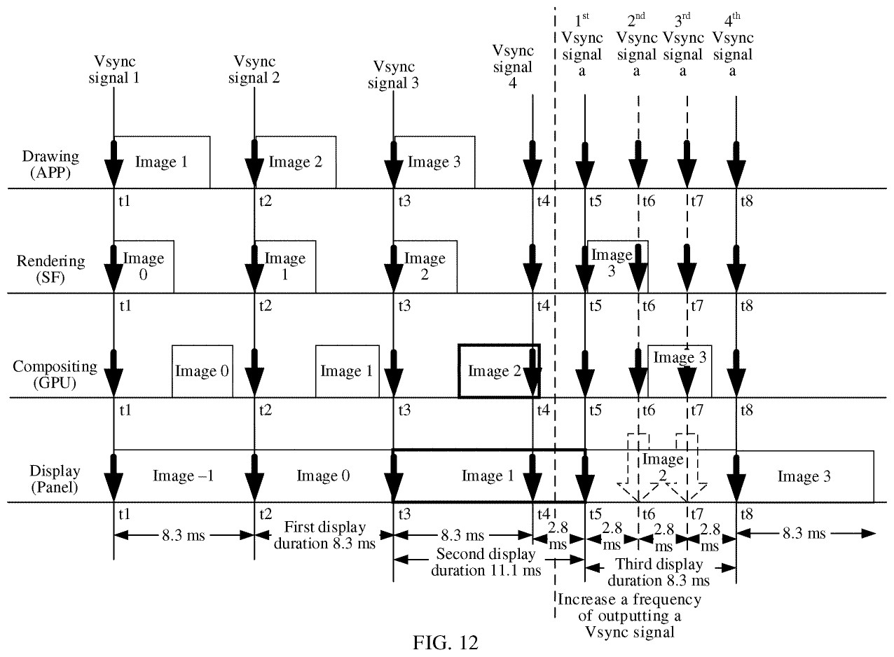

For example, as shown in FIG. 12, when the image display driver controls, after a time t4 (a time shown by a vertical dashed line in the figure), the display screen to increase the frequency of outputting the Vsync signal to M=3 times (360 Hz) the original frequency of 120 Hz, the display screen displays the third image (an image 2) at the third time (t5) in response to a third Vsync signal (the 1^{st} Vsync signal a) at an increased frequency. Then, the display screen continues to output the Vsync signal a at the increased frequency at 360 Hz. If the image display driver receives display data of the image 3 in the next frame of the image 2 before the display screen triggers the 4^{th} Vsync signal a at a time t8, the image display driver writes the received display data of the image 3 to the display screen in response to the 4^{th} Vsync signal a, to drive the display screen to display the image 3. In this way, the third display duration for which the display screen displays the image 2 is equal to the first display duration 8.3 ms for which the display screen displays the first image (the image 0).

It should be noted that times indicated by dashed arrows in FIG. 12 are all times at which the image display driver does not send an image to the display screen in response to the Vsync signal a.

In a feasible embodiment, the electronic device further generates a fourth Vsync signal at a fourth time after the second time and before the third time. In this case, if the image display driver of the electronic device has not received the display data of the third image in the next frame of the second image, the image display driver does not write display data of any image to the display screen in response to the fourth Vsync signal, so that the display screen continues to perform a prolonged display of the currently displayed second image in response to the fourth Vsync signal.

For example, as shown in FIG. 11 or FIG. 12, after the display screen starts to display the second image (the image 1) in response to the second time (t3), the display screen continues to trigger a fourth Vsync signal at the fourth time (t4) based on the second Vsync periodicity of 8.3 ms that is equal to the first Vsync periodicity. In this case, because the image display driver has not received the display data of the third image (the image 2) sent by the upper layer of the system of the electronic device, the image display driver does not write the display data of the image 2 to the display screen in response to the fourth Vsync signal. Therefore, at the time t4, the display screen can only continue to display the image 2 in response to the fourth Vsync signal. The second display duration for which the display screen displays the second image has reached 8.3 ms, so that after the time t4, the display of the second image on the display screen is a prolonged display. Then, at the third time (t5), because the display screen outputs the third Vsync signal (the 1^{st} Vsync signal a) at the increased frequency of 360 Hz of outputting the Vsync signal, and the image display driver receives the display data of the image 2 before t5, the image display driver can write the display data of the image 2 to the display screen in response to the 1^{st} Vsync signal a. The display screen starts to refresh and display the image 2 at t5 in response to the 1^{st} Vsync signal a.

In a feasible embodiment, when the display screen outputs the Vsync signal by using the frequency of 120 Hz as the original frequency, the first Vsync periodicity corresponding to the first Vsync signal generated by the electronic device through the display screen at the first time is approximately 8.3 ( 1/120≈8.3) ms. Then, if the electronic device increases the frequency at which the display screen outputs the Vsync signal to three times the original frequency of 120 Hz through the image display driver, that is, to 360 Hz, the third Vsync periodicity corresponding to the third Vsync signal generated by the electronic device through the display screen at the third time is approximately 2.8 ( 1/360≈2.8) ms after the frequency of outputting the Vsync signal is increased.

In a feasible embodiment, when the first Vsync periodicity is approximately 8.3 ms, and the third Vsync periodicity is approximately 2.8 ms, the first display duration corresponding to the first Vsync periodicity is also approximately 8.3 ms, and the second display duration for which the display screen displays the second image is approximately 8.3 ms+2.78 ms=11.1 ms.

For example, assuming that the display screen supporting the base frequency of 360 Hz initially outputs the Vsync signal at the original frequency of 120 Hz, after displaying the first image based on the first display duration 8.3 ms corresponding to the first Vsync periodicity of 8.3 ( 1/120≈8.3) ms, the display screen displays the second image in a next frame of the first image in response to a new Vsync signal. In a process of displaying the second image, if the display screen performs a prolonged display of the second image (where the second display duration is greater than the first display duration 8.3 ms), the image display driver controls the display screen to increase the frequency of outputting the Vsync signal to three times the original frequency, that is, to 360 Hz. In this way, the display screen outputs the Vsync signal at the frequency of 360 Hz, and the image display driver writes the display data of the third image in the next frame of the second image to the display screen in response to the Vsync signal, to drive the display screen to display the third image only after the prolonged display of the second image lasts for 2.8 ms. In this case, the complete second display duration for which the display screen displays the second image is approximately 8.3 ms+2.78 ms=11.1 ms.

In some feasible embodiments, when the image display driver of the electronic device increases the frequency at which the display screen outputs the Vsync signal to M times the original frequency of the Vsync signal, the image display driver may receive the display data of the third image in the next frame of the second image displayed on the display screen before the display screen outputs an i^{th} Vsync signal at the increased frequency. i is a positive integer, and i is less than M.

In this case, that the image display driver writes the display data of the third image to the display screen in response to the Vsync signal at the increased frequency may be: writing the display data of the third image to the display screen in response to the i^{th} Vsync signal at the increased frequency.

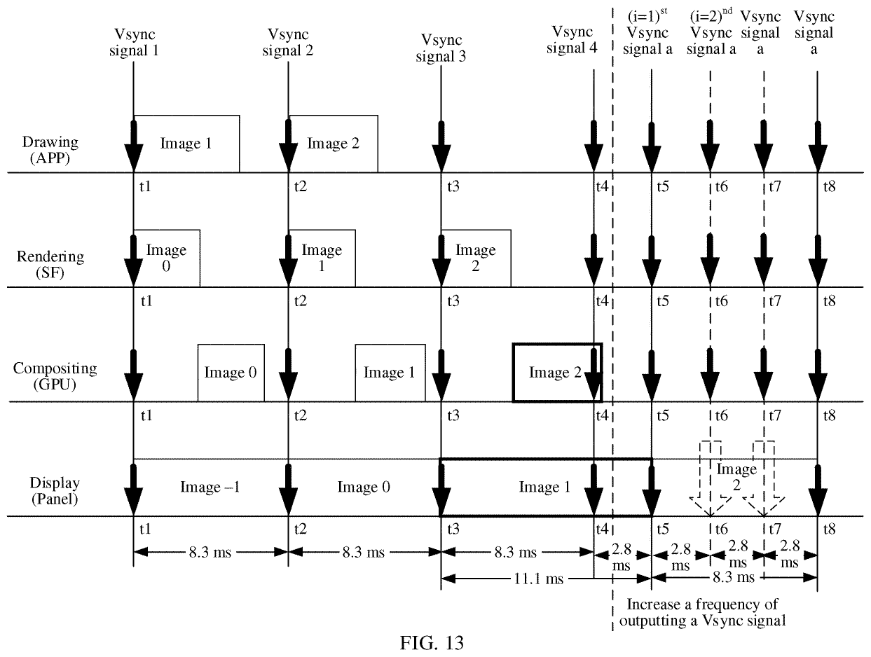

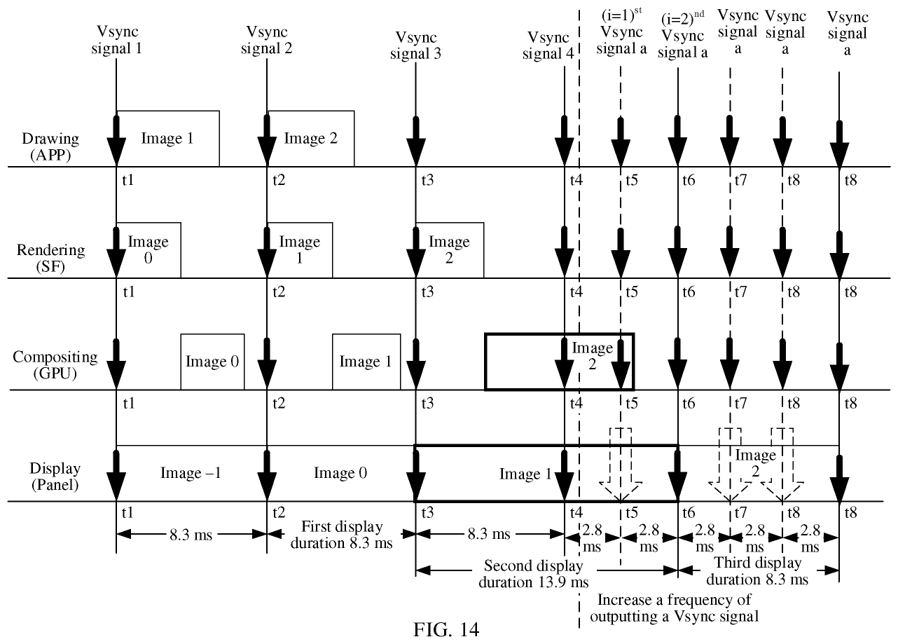

For example, as shown in FIG. 13, when the image display driver controls, after a time t4 (a time shown by a vertical dashed line in the figure), the display screen to increase the frequency of outputting the Vsync signal to M=3 times the original frequency of 120 Hz (that is, 360 Hz), if the upper layer of the system of the electronic device delivers the display data of the third image (the image 2) in the next frame of the second image (the image 1) displayed on the display screen to the image display driver before the display screen outputs the (i=1)^{st} Vsync signal a at the increased frequency at 360 Hz at the third time (t5), that is, the image display driver receives the display data of the image 2 before the time t5, the image display driver writes the display data of the image 2 to the display screen in response to the (i=1)^{st} Vsync signal a at the time t5, to drive the display screen to display the image 2. In this way, the image display driver delivers the image 2 for display within 2.8 ms after the prolonged display of the image 1 on the display screen. Therefore, the time required in the conventional solution in which the display screen delivers the image 2 for display after a long-time display of the image 1 for at least two consecutive Vsync periodicities (8.3 ms+8.3 ms=16.6 ms) is shortened to a case in which the display screen needs to send the image 2 to the display screen after displaying the image 1 for only 8.3 ms+2.8 ms=11.1 ms. That is, the duration for which the display screen performs the prolonged display of the image 1 is effectively reduced (from approximately 16.6 ms in the conventional solution to only approximately 2.8 ms).

For example, as shown in FIG. 14, if the upper layer of the system of the electronic device delivers the display data of the image 2 to the image display driver after the third time (t5), that is, the image display driver receives the display data of the image 2 before the display screen outputs the (i=2)^{nd} Vsync signal a at 360 Hz, the image display driver writes the received display data of the image 2 to the display screen in response to the (i=2)^{nd} Vsync signal a, to drive the display screen to display the image 2. In this case, the image display driver may alternatively deliver the image 2 for display after the display screen performs a prolonged display of the image 1 only for approximately 5.4 ms. Compared with the conventional solution in which the display screen performs a long-time display of the image 1 for approximately 16.6 ms, the display duration for which the display screen displays the image 1 can still be shortened to approximately 8.3 ms+5.4 ms=13.9 ms. That is, the duration for which the display screen performs the prolonged display of the image 1 is still effectively reduced (from approximately 16.6 ms in the conventional solution to only approximately 5.4 ms).

It should be noted that times indicated by dashed arrows in FIG. 13 and FIG. 14 are all times at which the image display driver does not send an image to the display screen in response to the Vsync signal a.

In some other feasible embodiments, M may not be a positive integer, but M is still greater than 1.

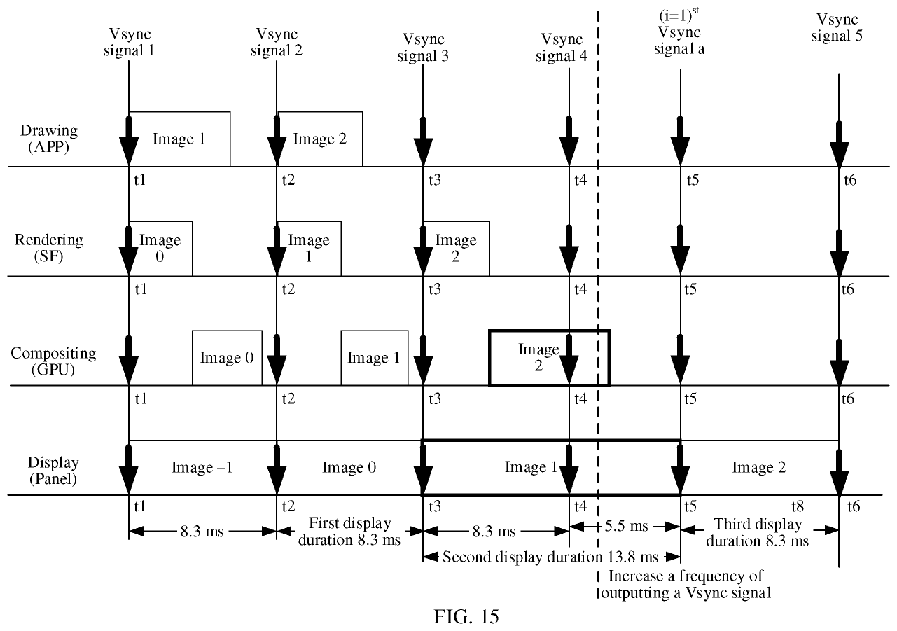

For example, as shown in FIG. 15, the image display driver controls, after a time t4 (a time shown by a vertical dashed line in FIG. 13), the display screen to increase the frequency of outputting the Vsync signal to M=1.5 times the original frequency of 120 Hz (that is, 180 Hz). In this way, if the upper layer of the system of the electronic device delivers the display data of the third image (the image 2) in the next frame of the second image (the image 1) displayed on the display screen to the image display driver before the display screen triggers the (i=1)^{st} Vsync signal a at the increased frequency at 180 Hz at the third time (t5), that is, the image display driver receives the display data of the image 2 before the time t5, the image display driver writes the display data of the image 2 to the display screen in response to the (i=1)^{st} Vsync signal a at the time t5, to drive the display screen to display the image 2. In this way, the image display driver may deliver the image 2 for display after the display screen performs a prolonged display of the image 1 for approximately 5.5 ms. Compared with the conventional solution in which the display screen performs a long-time display of the image 1 for approximately 16.6 ms, the display duration for which the display screen displays the image 1 can still be shortened to approximately 13.8 ms. That is, the duration for which the display screen performs the prolonged display of the image 1 is still effectively reduced.

In this embodiment of this application, before the display screen outputs the i^{th} Vsync signal at the increased frequency, the image display driver of the electronic device receives the display data of the third image, and writes, in response to the received i^{th} Vsync signal at the increased frequency, the display data of the third image to the display screen to drive the display screen to display the third image. This way can ensure that the image display driver of the electronic device delivers a next frame of image for display in response to the Vsync signal at the increased frequency that is triggered by the display screen within a short prolonged display of an image on the display screen. That is, the duration for which the display screen performs the prolonged display of the second image is effectively reduced.

In some feasible embodiments, the image display driver of the electronic device calculates, in response to the display screen displaying the second image, the second display duration for which the display screen displays the second image. In addition, the image display driver compares the second display duration with the first display duration. When the second display duration is greater than the first display duration, the image display driver sends a control instruction to the display screen in response to the second display duration being greater than the first display duration. The display screen increases a frequency of outputting a Vsync signal in response to the control instruction, and generates the third Vsync signal at an increased frequency at the third time after the second time.

For example, a delay detection module is configured in the image display driver of the electronic device, and whether the second display duration is greater than the first display duration is detected by using the delay detection module, to improve the frequency of outputting the Vsync signal when the delay detection module detects that the second display duration is greater than the first display duration. In this way, because the image display driver is located at a kernel layer of an entire system of the electronic device, whether the second display duration is greater than the first display duration due to an upper layer of a system (for example, an application layer, an application framework layer, or a hardware abstraction layer) or due to the kernel layer itself, it can be detected by using the delay detection module newly added in the kernel layer. That is, comprehensiveness and accuracy in detecting whether the second display duration is greater than the first display duration are improved.

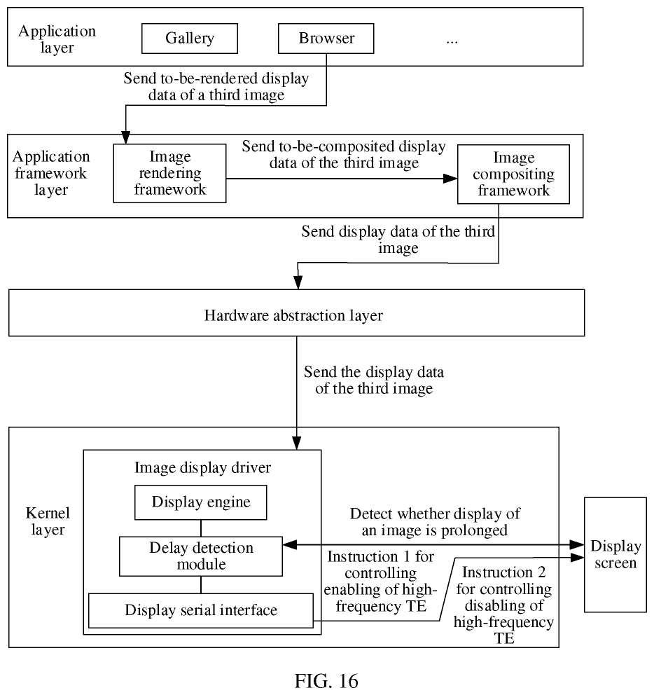

In this embodiment of this application, the electronic device may determine whether to increase the frequency of outputting the Vsync signal by combining improvements at the software level and the hardware level. In other words, a hardware module is newly added to the kernel layer of the system of the electronic device, and the hardware module is used to detect whether a delay occurs in a displayed picture of the device (that is, detects whether a display duration for an image on the display screen is prolonged), so that when the hardware module detects that a delay occurs in the displayed picture of the device, a frequency at which the display screen outputs the Vsync signal is increased to reduce a degree of the delay in the displayed picture of the device. As shown in FIG. 16, a delay detection module is newly configured in the image display driver in the kernel layer of the electronic device. Based on this, in response to the display screen starting to display the second image, the electronic device continuously calculates, by using the delay detection module, the second display duration for which the display screen displays the second image, and detects whether the second display duration is greater than the first display duration. Then, when detecting that the second display duration is greater than the first display duration, the delay detection module determines that a delay occurs in the displayed picture of the device, so that the image display driver delivers a control instruction to the display screen, to control the display screen to increase the frequency of outputting the Vsync signal.

It should be noted that in this embodiment of this application, in an image display process of the display screen, the image display driver continuously detects, by using the delay detection module, whether the display duration for the image on the display screen is prolonged. The image display driver in the kernel layer, applications in the application layer, an image rendering framework and an image compositing framework in the application framework layer, and the hardware abstraction layer of the electronic device, if missing the Vsync signal triggered by the display screen at the original frequency, all cause the second display duration to be greater than the first display duration, causing the image displayed on the display screen to be in a delayed state.

In this embodiment of this application, when detecting whether the second display duration is greater than the first display duration, the image display driver of the electronic device may detect, by using the newly added delay detection module in a process in which the display screen displays the second image, whether the second display duration for which the display screen displays the second image is greater than the first display duration corresponding to the first Vsync. When the delay detection module detects that the second display duration is greater than the first display duration, the image display driver determines that the display of the second image on the display screen has been prolonged, causing the image displayed on the display screen to be in the delayed state.

When determining that the second display duration is greater than the first display duration, to improve the frequency at which the display screen outputs the Vsync signal, the image display driver may deliver the control instruction to the display screen by using the display serial interface that establishes communication connection between the image display driver and the display screen. The display screen immediately responds after receiving the control instruction, to increase the frequency of outputting the Vsync signal from the original frequency to the frequency indicated by the control instruction.

In this embodiment of this application, when the delay detection module detects that the second display duration is greater than the first display duration, the image display driver of the electronic device immediately increases the frequency at which the display screen outputs the Vsync signal, and writes the display data of the third image to the display screen in response to the Vsync signal at the increased frequency, to drive the display screen to display the third image. This can effectively reduce the duration for which the display screen performs the prolonged display of the image, to reduce a degree of a delay in the displayed picture of the device, and can also improve comprehensiveness of detecting whether the display of the second image on the display screen is prolonged, and improve accuracy of increasing the frequency of outputting the Vsync signal to cause the image display driver to immediately deliver the third image for display. The delay detection module is configured in the image display driver in the kernel layer of the system of the electronic device. Therefore, whether the prolonged display of the second image on the display screen is caused by the kernel layer at which the delay detection module is located, or by the application layer, the application framework layer, or the hardware abstraction layer of the system can be detected by the delay detection module.

In some feasible embodiments, before detecting whether the second display duration is greater than the first display duration by using the delay detection module, the image display driver of the electronic device detects whether the image display driver responds to the Vsync signal triggered by the display screen at the original frequency.

In this embodiment of this application, the image display driver of the electronic device detects, by using the delay detection module, whether the display of an image on the display screen is in the delayed state in each process in which the display screen refreshes and displays the image. In other words, in addition to detecting, by using the delay detection module when the display screen displays the second image, whether a delay occurs in the display of the image on the display screen (where the second display duration exceeding the first display duration indicates that a delay occurs in the display of the second image on the display screen), the image display driver also detects, by using the delay detection module when the display screen displays the first image, whether the display of the first image on the display screen is in a delayed state. Then, when the image display driver detects, by using the delay detection module, that the display of the first image on the display screen is not in the delayed state, the image display driver further detects, by using the delay detection module, whether the display of the second image on the display screen is delayed, that is, detects whether the second display duration exceeds the first display duration.

In this embodiment of this application, that the image display driver detects, by using the delay detection module, whether the display of the first image on the display screen is in the delayed state may be: detecting, by using the delay detection module, whether the image display driver writes the display data of the second image to the display screen in response to the first Vsync signal triggered at the original frequency by the display screen at the first time, so as to drive the display screen to display the second image when the display screen does not perform a prolonged display of the first image. If it is detected that the image display driver drives, in response to the first Vsync signal, the display screen to display the second image, it is determined that the display of the first image on the display screen is not in the delayed state. If it is detected that the image display driver does not respond to the first Vsync signal (or misses the first Vsync signal), causing a prolonged display of the first image on the display screen, it is determined that the display of the first image on the display screen is in the delayed state.

In some feasible embodiments, if the image display driver detects, by using the delay detection module, that the image display driver writes the display data of the second image to the display screen in response to the first Vsync signal, to determine that no delay occurs in the display of the first image on the display screen, the image display driver detects, by using the delay detection module, whether the second display duration is greater than the first display duration, to determine, based on a detection result, whether a delay occurs in the display of the second image on the display screen. When it is determined that a delay occurs in the display of the second image on the display screen, the image display driver controls the display screen to increase the frequency of outputting the Vsync signal.

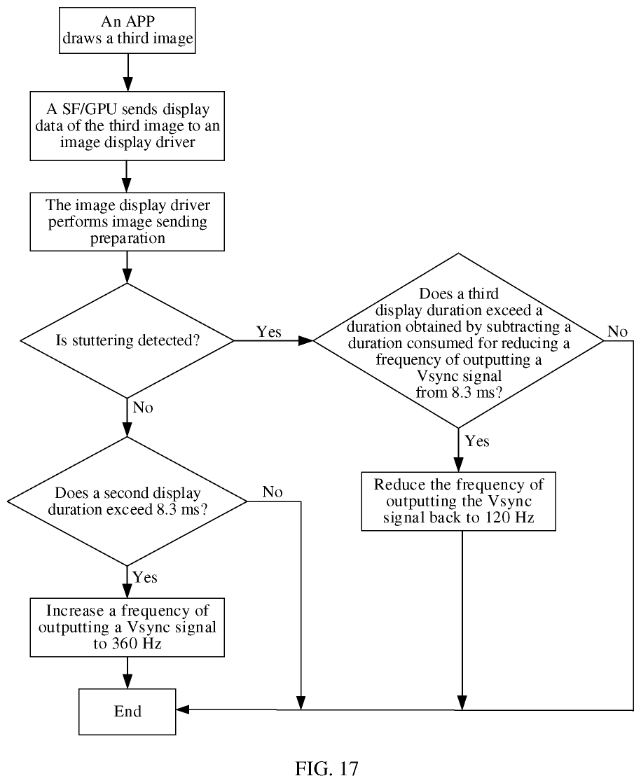

For example, with reference to a system framework of an electronic device shown in FIG. 16 and control logic of image display by applying the method provided in this embodiment of this application to an electronic device shown in FIG. 17, assuming that a display screen of the electronic device supports a base frequency of 360 Hz, when the display screen performs image display in a first Vsync periodicity of 8.3 ms corresponding to a refresh rate of 120 Hz, in a process in which the display screen displays the second image, a browser application APP in the application layer of the system of the electronic device synchronously draws the third image in a next frame of the second image, and sends display data of the third image, which has been drawn but requires rendering, to an image rendering service in the application frame layer. After the image rendering service completes rendering of the display data, if the display data requires further compositing, the rendered display data is further sent to an image compositing service. After the display data is composited by the image compositing service, the display data is delivered as the display data of the to-be-displayed third image to the hardware abstraction layer, so that the hardware abstraction layer performs hardware matching to send the display data of the third image to the image display driver in the kernel layer. The image display driver performs image sending preparation after receiving the display data of the third image.

In this case, the image display driver obtains a result previously detected by using the delay detection module, and when the result is that the display of the first image on the display screen is not in the delayed state (the first display duration does not exceed 8.3 ms), the delay detection module is further used to detect whether the second display duration for which the display screen displays the second image is greater than 8.3 ms. When it is detected that the second display duration is greater than 8.3 ms, the image display driver immediately sends, to the display screen by using the display serial interface (DSI) that establishes communication connection between the image display driver and the display screen, an instruction 1 for controlling enabling of high-frequency TE, so as to control the display screen to enable a preset 360 Hz-TE high-frequency synchronization scheme in response to the instruction 1, thereby increasing the frequency at which the display screen outputs the Vsync signal to 360 Hz.

Alternatively, when the image display driver obtains the result previously detected by using the delay detection module, but the result is that the display of the first image on the display screen has been in the delayed state (the first display duration exceeds 8.3 ms), it indicates that when the display screen displays the first image, a delay caused by a prolonged display of the image has occurred on the display screen, and in order to reduce a degree of the delay, the image display driver has controlled the display screen to increase the frequency of outputting the Vsync signal to 360 Hz.

In some feasible embodiments, after the image display driver of the electronic device increases the frequency of outputting the Vsync signal, to drive, in response to the Vsync signal at the increased frequency, the display screen to display an image, in order to avoid a phenomenon that the display screen quickly displays a next frame of image of the image only after briefly displaying the image due to the image display driver delivering the next frame of image for display in advance, the image display driver may not respond to the Vsync signal at the increased frequency that is output by the display screen within a display duration for which the display screen displays the image, so that the electronic device may forcibly extend the duration for which the display screen displays the image.

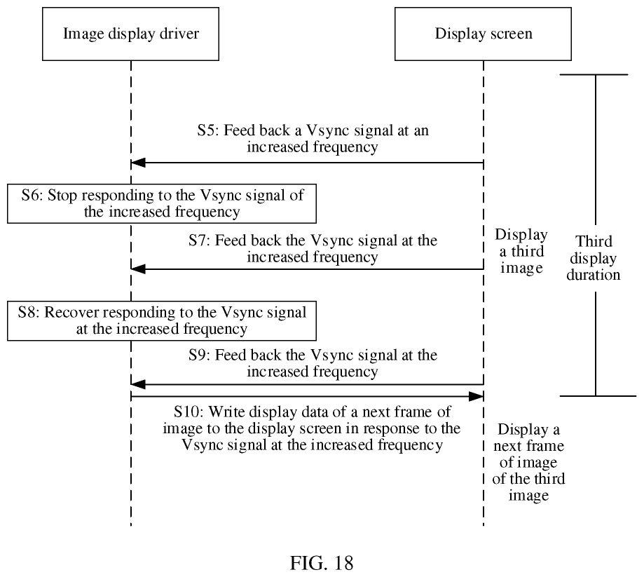

In this embodiment of this application, the electronic device may forcibly extend, through steps S5 and S10 shown in FIG. 18, the duration for which the display screen displays the third image. After displaying the third image, the display screen performs step S5: Feed back a Vsync signal at an increased frequency. When receiving the Vsync signal at the increased frequency that is fed back by the display screen, if the third display duration for which the display screen displays the third image is not greater than a difference between the first display duration and the third Vsync periodicity, the image display driver performs step S6: Stop responding to the Vsync signal at the increased frequency. Then, the display screen continues to perform step S7: Feed back the Vsync signal at the increased frequency. However, after the image display driver receives the Vsync signal at the increased frequency that is fed back by the display screen, if the third display duration is greater than the difference between the first display duration and the third Vsync periodicity, the image display driver performs S8: Resume responding to the Vsync signal at the increased frequency. Then, the display screen performs step S9: Feed back the Vsync signal at the increased frequency. After receiving the Vsync signal, the image display driver performs step S10: Write display data of a next frame of image to the display screen in response to the Vsync signal at the increased frequency. In this way, the display screen starts to display the next frame of image.

In this embodiment of this application, after the image display driver of the electronic device writes the display data of the third image to the display screen to drive the display screen to display the third image, the image display driver stops, within the third display duration for which the display screen displays the third image, responding to the Vsync signal at the increased frequency that is output by the display screen within the third display duration, to reject to write display data of a next frame of image of the third image to the display screen within the third display duration.

Then, only when the third display duration is greater than the difference between the first display duration and the third Vsync periodicity, the image display driver resumes responding to the Vsync signal at the increased frequency that is output by the display screen, to write the display data of the next frame of image of the third image to the display screen after the third display duration reaches the first display duration.

In this embodiment of this application, the image display driver does not respond to the Vsync signal at the increased frequency that is triggered by the display screen within the third display duration for which the display screen displays the third image, to avoid a phenomenon that the display screen briefly displays the third image due to the image display driver delivering a next frame of image of the third image for display in advance in a process in which the display screen displays the third image. In this way, stability of the electronic device in displaying the third image and its subsequent images is further improved.

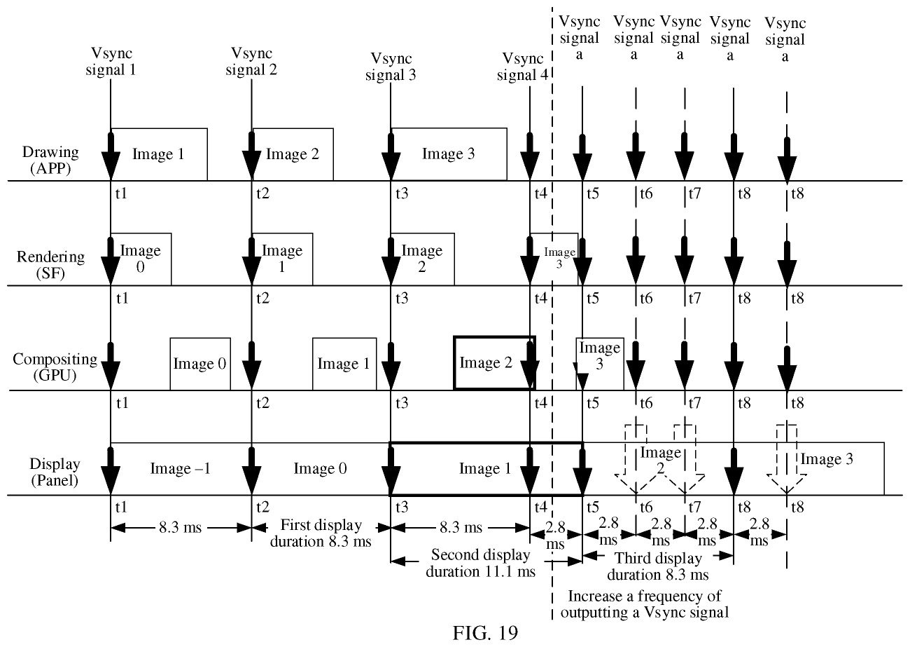

For example, as shown in FIG. 19, it is assumed that the image display driver of the electronic device detects, after the time t4, that the second display duration for which the display screen displays the second image at the refresh rate of 120 Hz is greater than the first display duration corresponding to the first Vsync periodicity ( 1/120 Hz) by approximately 8.3 ms, and controls, at a time shown by a dashed line between the time t4 and the time t5, the display screen to increase the frequency of the output vertical synchronization signal from the original frequency of 120 Hz to 360 Hz. In this case, in response to the third Vsync signal (the Vsync signal a) at the increased frequency that is output by the display screen at the third time (t5) based on the third Vsync periodicity corresponding to the frequency of 360 Hz ( 1/360≈2.8 ms), when the display screen performs a prolonged display of only the second image (the image 1) for approximately 2.8 ms, the image display driver writes the third image (the image 2) to the display screen to drive the display screen to display the image 2.

Then, because the display screen increases the frequency of outputting the Vsync signal to 360 Hz, the display screen still continues to output, based on the third Vsync periodicity corresponding to the frequency of 360 Hz, a new Vsync signal a (shown by the dashed line at the time t6 in the figure) at a time t6 after displaying the image 2 for approximately 2.8 ms. In this case, because the duration for which the display screen displays the image 2 is only approximately 2.8 ms, the image display driver stops responding to the Vsync signal a received at the time t6 (times indicated by dashed arrows in the figure are all times at which the image display driver does not respond to the Vsync signal a to send an image to the display screen), to reject to write display data of a next frame of image (the image 3) of the image 2 to the display screen at the time t6.

The display screen then continues to output a new Vsync signal a again at a time t7 (shown by a dashed line at which the time t7 is located) after displaying the image 2 for approximately 2.8 ms. In this case, because the second display duration for which the display screen displays the image 2 still is only 5.4 ms, that is, the second display duration does not reach the first display duration of approximately 8.3 ms, the image display driver still does not respond to the Vsync signal a at the time t7, to reject to write the display data of the image 3 to the display screen at the time t7.

However, thereafter, when the second display duration is greater than 5.5 ms (subtracting the third Vsync periodicity of approximately 2.8 ms from the first display duration of 8.3 ms), the image display driver resumes responding to the Vsync signal a output by the display screen. Therefore, the display screen continues to output a new Vsync signal a at a time t8 after further displaying the display image 2 for 2.8 ms (in this case, the second display duration has been approximately equal to 8.3 ms). In this case, because the second display duration has reached 8.3 ms, the image display driver writes the display data of the image 3 to the display screen in response to the Vsync signal a at the time t8.

This can ensure that the duration for which the display screen displays the image 2 reaches approximately 8.3 ms. Then, provided that the display screen continues to trigger a new Vsync signal a at the frequency of 360 Hz, in a process in which the display screen displays the image 3 and subsequent images (if exist), the image display driver sends the image to the display screen in response to the Vsync signal a with reference to the same processing process of sending the image to the display screen during the display of the image 2 on the display screen.

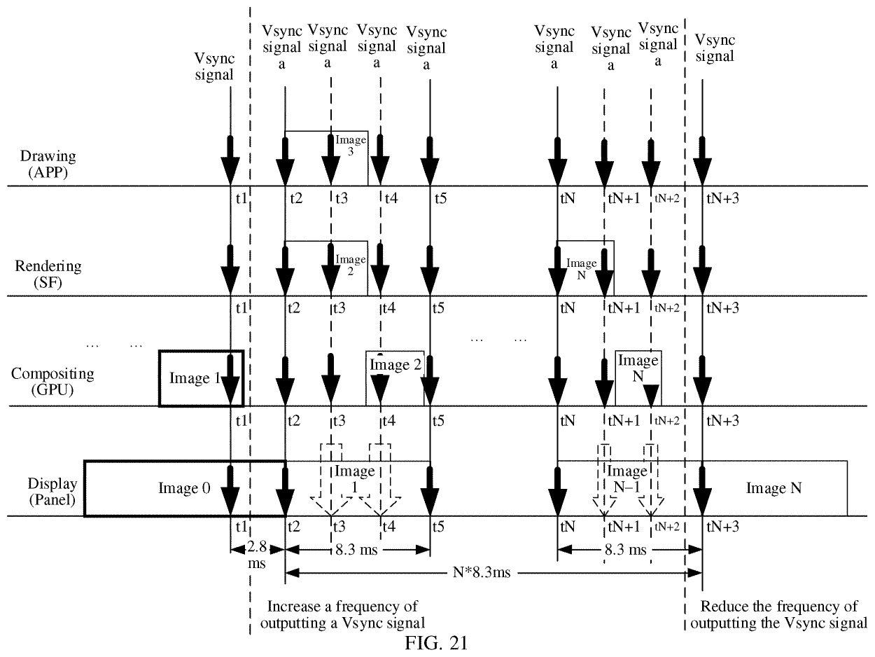

It should be noted that in this embodiment of this application, the processing process shown in FIG. 19, in which the image display driver does not respond to the Vsync signal a to send an image to the display screen in the process in which the display screen displays the image 2, is also applicable to example scenarios shown in FIG. 12, FIG. 13, and FIG. 14, and to an example scenario described below with reference to FIG. 21. In other words, in the example scenarios shown in FIG. 12, FIG. 13, and FIG. 14 above, and FIG. 21 below, in the process in which the display screen displays the third image and subsequent images (if exist), the process in which the image display driver continues to writes display data of a next frame of image of the third image to the display screen in response to the Vsync signal a at the increased frequency is the same as the process in which the image display driver sends the image 3 to the display screen in response to the Vsync signal a during the display of the image 2 on the display screen shown in FIG. 19, and details are not described herein again.

In some feasible embodiments, when the image display method provided in this embodiment of this application is performed by the electronic device, after the image display driver writes the display data of the third image to the display screen, to drive the display screen to immediately display the third image, the image display driver may further adaptively reduce the frequency of the Vsync signal. This can avoid power consumption waste caused by the display screen continuously outputting the Vsync signal at an unnecessary high frequency, thereby reducing power consumption of the device.

In this embodiment of this application, after the display screen of the electronic device displays the third image in response to the third Vsync signal, if the third display duration for which the display screen displays the third image is greater than a preset time interval, the electronic device reduces the frequency of outputting the Vsync signal. The preset time interval is equal to the duration obtained by subtracting the duration consumed for reducing the frequency of outputting the Vsync signal from the first display duration. That is, the preset time interval is a difference between the first display duration and the duration consumed for reducing the frequency of outputting the Vsync signal.

It should be noted that in this embodiment of this application, the duration consumed for reducing the frequency of outputting the Vsync signal may be an empirical value added to the image display driver in advance, for the image display driver to flexibly read. Alternatively, the consumed duration may be a value temporarily determined by the electronic device based on its real-time system resource usage and, performance when the electronic device needs to determine the preset time interval. The value temporarily determined may be obtained by the image display driver at any time. It should be understood that based on different design requirements in actual applications, the duration consumed for reducing the frequency of outputting the Vsync signal may certainly vary. For example, the consumed duration may be specifically any value of 0.3 ms, 0.5 ms, 0.8 ms, or even 1 ms. In other words, the method provided in this embodiment of this application does not impose any limitation on a specific value of the duration required for reducing the frequency of outputting the Vsync signal.

As shown in FIG. 16 and FIG. 17, after the image display driver of the electronic device has controlled the display screen to increase the frequency at which the display screen outputs the Vsync signal to 360 Hz, to reduce a degree of a delay caused by a prolonged display of an image on the display screen, in order to avoid a waste of power consumption of the device caused by the display screen still triggering the Vsync signal at 360 Hz, the image display driver calculates a time interval b from a current time to a time at which the image display driver writes the display data of the first image to the display screen, and compares the time interval b with a duration of 7.3 ms, which is obtained by subtracting the consumed duration (assumed to be 1 ms) for reducing the Vsync signal from the first display duration of approximately 8.3 ms. Therefore, when it is found through comparison that the time interval b is greater than or equal to 7.3 ms, the image display driver determines that the current operation of increasing the frequency of outputting the Vsync signal has reduced a delay occurring when the display screen displays the second image. That is, the display of the third image by the display screen has become stable. In this way, the image display driver sends an instruction 2 for controlling disabling of high-frequency TE to the display screen through the DSI, to control the display screen to disable the preset 360 Hz-TE high-frequency synchronization scheme in response to the instruction 2, to reduce the frequency at which the display screen outputs the Vsync signal from 360 Hz back to 120 Hz.

In some feasible embodiments, the image display driver may alternatively obtain a current time from the system of the electronic device after the display screen displays the third image, and subtract an image sending time at which the image display driver previously responds to the Vsync signal at the increased frequency (a time at which the display data of the third image is written to the display screen) from the current time, to determine the calculated duration as the third display duration for which the display screen displays the third image. The third display duration is then compared with the preset time interval.

Alternatively, in some other feasible embodiments, the image display driver may directly compare the duration obtained by subtracting the image sending time from the current time with the preset time interval. Therefore, when the duration obtained by subtracting the image sending time from the current time is greater than or equal to the preset time interval, the previously increased frequency of outputting the Vsync signal is reduced.

In some feasible embodiments, after the display screen starts to display the third image, the image display driver of the electronic device may reduce the frequency of outputting the Vsync signal when the display data of the next frame of image of the third image is received within the third display duration for which the display screen displays the third image. In this way, the electronic device generates a fifth Vsync signal at a fifth time after the third time.

It should be noted that in this embodiment of this application, the fifth Vsync signal corresponds to a fifth Vsync periodicity, and is equal to the first Vsync periodicity.

In some feasible embodiments, a display duration of a fourth image is greater than a preset time interval; and the fourth image is an image displayed in the previous frame of the fifth time, the preset time interval is obtained by subtracting a duration consumed for reducing a frequency of outputting a Vsync signal from a time interval between the fifth time and a sixth time, and the sixth time is a time at which the fourth image is written to the display screen.

In this embodiment of this application, after the display screen starts to display the third image, in response to the display duration of the fourth image being greater than the duration obtained by subtracting the duration consumed for reducing the frequency of outputting the Vsync signal from the time interval between the fifth time and the sixth time, the electronic device reduces the frequency of outputting the Vsync signal. Then, at the fifth time after the third time, the electronic device generates the fifth Vsync signal having a Vsync periodicity equal to the first Vsync periodicity.

It should be noted that in this embodiment of this application, the fourth image is the third image itself or a frame of image after the third image. The sixth time is a time at which the fourth image is written to the display screen. In other words, when the fourth image is the third image itself, the sixth time is the third time at which the display screen starts to display the third image in response to the third Vsync signal (in this case, the third image is written to the display screen and starts to be displayed on the display screen). When the fourth image is a frame of image after the third image, the sixth time is a time at which the display screen starts to display the frame of image after the third image (in this case, the frame of image after the third image is written to the display screen and starts to be displayed on the display screen). The duration between the fifth time and the sixth time is the first display duration corresponding to the first Vsync periodicity.

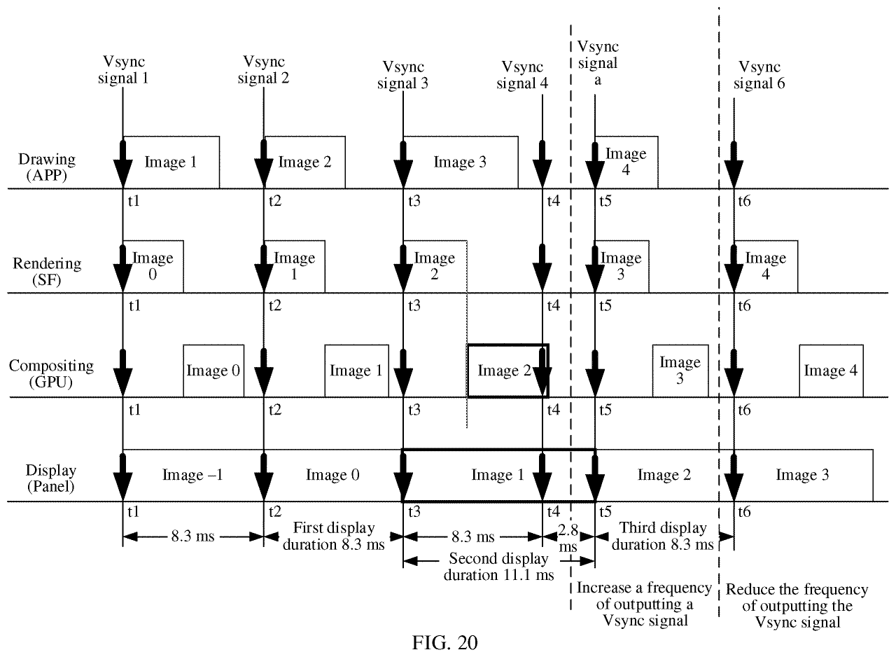

For example, as shown in FIG. 20, an example in which the fourth image is the third image itself and the sixth time is the third time is used. After the display screen starts to display the third image (an image 2) at the third time (t5), the electronic device calculates the third display duration of the image 2 in real time. When the third display duration is greater than the duration obtained by subtracting the duration consumed for reducing the frequency of outputting the Vsync signal (where the consumed duration is a duration between a time shown by a vertical dashed line on the right side of the figure and t6) from the time interval 8.3 ms between the fifth time (t6) and t5, the electronic device reduces the frequency of outputting the Vsync signal at the time shown by the vertical dashed line on the right side of the figure. In this way, at the time t6, the electronic device generates the fifth Vsync signal (a Vsync signal 6) having a fifth Vsync periodicity of 8.3 ms (which is equal to the first Vsync periodicity).

In some feasible embodiments, if the electronic device reduces, by using the image display driver, the frequency at which the display screen outputs the Vsync signal in the process in which the display screen displays the third image, the fifth time at which the electronic device generates the fifth Vsync signal by using the display screen is N=1 8.3 ms apart from the third time at which the display screen outputs the third Vsync signal.

For example, as shown in FIG. 20, when detecting a prolonged display of the image 1 on the display screen by using the delay detection module after the time t4, the electronic device increases the frequency at which the display screen outputs the Vsync signal (a time shown by a vertical long dashed line on the left side of the figure is a time at which the frequency of outputting the Vsync signal is increased), so that the display screen outputs the third Vsync signal (the Vsync signal a) at the increased frequency at the third time (t5). The image display driver writes to the display screen, in response to the Vsync signal a at the time t5, the display data of the third image (the image 2) that has been composited by the GPU and delivered to the image display driver, so that the display screen starts to display the image 2 after the second display duration for which the display screen displays the second image (the image 1) is prolonged by approximately 2.8 ms. However, after the display screen displays the image 2, if the image display driver receives, within 8.3 ms for which the display screen displays the image 2, the display data of the image 3 sent by the GPU (that is, the display data of the image 3 is received before the time t6), it is determined that the current display of the image 2 on the display screen has become stable, so that a control instruction is sent to the display screen to reduce the frequency of outputting the Vsync signal (a time shown by a vertical long dashed line on the right side of the figure is a time at which the output Vsync signal is reduced). In this way, the display screen can feed back the fifth Vsync signal (a Vsync signal 6 of the original frequency) to the image display driver, the APP, the SF, and the GPU at the fifth time (t6) approximately 8.3 ms after t5, and the image display driver can write the display data of the image 3 to the display screen in response to the Vsync signal 6, to drive the display screen to display the image 3.

In this embodiment of this application, according to the method provided in this embodiment of this application, the image display driver receives the display data of the next frame of image of the third image within the third display duration for which the display screen displays the third image, so that after it is determined that the display of the third image on the display screen has become stable, the frequency at which the display screen outputs the Vsync signal is reduced. This can avoid power consumption waste caused by the display screen continuously outputting the Vsync signal at a high frequency after the display of the third image on the display screen has become stable, thereby reducing power consumption of the device.

It should be noted that the Vsync signal of the original frequency is a Vsync signal triggered by the display screen at the original frequency before the image display driver increases the frequency of outputting the Vsync signal. For example, it is assumed that the display screen initially triggers the Vsync signal at a frequency of 120 Hz and feeds back the Vsync signal to the image display driver. Then, in a process in which the display screen displays the second image, because the display screen performs a prolonged display of the second image, the image display driver increases the frequency of outputting the Vsync signal to 360 Hz, and sends an image to the display screen in response to the third Vsync signal triggered at the frequency of 360 Hz by the display screen at the third time, to drive the display screen to display the third image. In this case, the third Vsync signal triggered at the frequency of 360 Hz by the display screen is a Vsync signal at the increased frequency. The image display driver then determines that the display of the third image by the display screen has become stable, thereby sending the control instruction to the display screen to reduce the frequency of outputting the Vsync signal, that is, from 360 Hz to 120 Hz. Therefore, the fifth Vsync signal triggered at the frequency of 120 Hz by the display screen at the fifth time is the Vsync signal at the original frequency.

In some other feasible embodiments, in addition to immediately reducing the frequency of outputting the Vsync signal after determining that the display of the third image on the display screen has become stable, the image display driver of the electronic device may further reduce the frequency of outputting the Vsync signal after determining that the display of the third image and a plurality of subsequent consecutive frames of images on the display screen has become stable. This can reduce continuous stuttering in the image display process on the electronic device.

It should be noted that in this embodiment of this application, due to a high temperature from long-time running of the electronic device or insufficient system resources, the upper layer of the system and/or the image display driver may fail to respond to the vertical synchronization signal in time for image processing, resulting in continuous stuttering on the display screen in the image display process.

In this embodiment of this application, if the electronic device reduces the frequency at which the display screen outputs the Vsync signal in a process of displaying an (N−1)^{th} image after the third image by using the image display driver, the fifth time at which the fifth Vsync signal is generated by the electronic device by using the display screen is only N 8.3 ms apart from the third time at which the display screen outputs the third Vsync signal. In this case, N is a positive integer greater than 1.

In this embodiment of this application, after the display screen starts to display the third image, the image display driver of the electronic device may detect, frame by frame, whether the image display driver receives display data of an N^{th} frame of image after the third image within a display duration of the (N−1)^{th} frame of image after the display screen displays the third image. In this way, the image display driver reduces the frequency at which the display screen outputs the Vsync signal only when continuously detecting that the image display driver receives the display data of the N^{th} frame of image within the display duration for which the display screen displays the (N−1)th frame of image.

It should be noted that in this embodiment of this application, N is a positive integer greater than 1. Similar to the duration consumed for reducing the Vsync signal, a specific value of N may alternatively be an empirical value added to the image display driver in advance, or N may alternatively be a value that is temporarily determined by the electronic device based on its real-time system resource usage, remaining battery capacity, and performance. It should be understood that based on different design requirements in actual applications, certainly, N may be different positive integers greater than 1. In other words, the method provided in this embodiment of this application also does not impose any limitation on a specific value of N.

For example, as shown in FIG. 21, when detecting a prolonged display of the image 0 on the display screen by using the delay detection module after the time t1, the electronic device increases the frequency at which the display screen outputs the Vsync signal (a time shown by a vertical long dashed line on the left side of the figure is a time at which the frequency of outputting the Vsync signal is increased). The display screen then outputs, at the third time (t2), the third Vsync signal (the Vsync signal a) at the increased frequency, so that the image display driver writes the display data of the third image (the image 1) to the display screen in response to the Vsync signal a at the time t2, to cause the display screen to display the image 1 after the duration for which the display screen displays the image 0 is prolonged by approximately 2.8 ms (the third Vsync periodicity of 1/360 Hz corresponding to the third Vsync). When the display screen displays an image N−1 after the image 1 (the (N−1)^{th} frame of image after the image 1), if the image display driver also receives the display data of an image N sent by the GPU within 8.3 ms for which the display screen displays the image N−1, it is determined that the current display of a plurality of consecutive frames of images on the display screen has been stable, so that the frequency of outputting the Vsync signal is reduced (a time indicated by the vertical long dashed line on the right side of the figure is a time of reducing the output Vsync signal). In this way, the display screen can feed back the fifth Vsync signal to the image display driver, the APP, the SF, and the GPU at the fifth time (tN+3) after the third time, and the image display driver writes the display data of the image N to the display screen in response to the fifth Vsync signal, to drive the display screen to display the image N.

In this embodiment of this application, after the display screen displays the third image, the image display driver of the electronic device continues, in response to the Vsync signal at the increased frequency that is triggered by the display screen, writes the display data of the next frame of image of the third image to the display screen to drive the display screen to display the next frame of image, until the display screen is driven to display the (N−1)^{th} frame of image after the third image. The image display driver detects whether the image display driver receives the display data of the N^{th} frame of image after the third image of the electronic device within the display duration for which the display screen displays the (N−1)^{th} frame of image (the N^{th} frame of image is located after the (N−1)^{th} frame of image). In addition, after the image display driver receives the display data of the N^{th} frame of image within the display duration for which the display screen displays the (N−1)^{th} frame of image, the image display driver determines that the display of the (N−1)^{th} frame of image after the third image has been stable, thereby reducing the frequency at which the display screen outputs the Vsync signal.

In this embodiment of this application, the electronic device reduces the frequency of outputting the Vsync signal after determining that the display of the (N−1)^{th} frame of image after the third image by the display screen has become stable, thereby avoiding power consumption waste caused by the display screen outputting the Vsync signal at a high frequency after the display of the image has become stable. Moreover, after the display of the (N−1)^{th} frame of image after the third image on the display screen has become stable, the frequency of outputting the Vsync signal is reduced, further avoiding frequently increasing and reducing, by the image display driver, the frequency of outputting the Vsync signal, thereby further reducing power consumption required for the device to frequently adjust the frequency of outputting the Vsync signal.

In some other feasible embodiments, after the display screen displays the third image, the image display driver of the electronic device may further detect, for each frame of image after the third image, whether display data of a next frame of image of an image displayed on the display screen is received within a display duration of a single frame of image of the image displayed on the display screen. In a process in which the display screen displays each frame of image from the third image to the (N−1)^{th} frame of image after the third image, it is continuously detected that whether the image display driver receives the display data of the N^{th} frame of image within the display duration for which the display screen displays the (N−1)^{th} frame of image. Therefore, only when it is detected that yes (the display data of the N^{th} frame of image is received within the display duration for which the display screen displays the (N−1)^{th} frame of image), the image display driver reduces the frequency of outputting the Vsync signal. This can more accurately prevent the image display driver from frequently increasing and decreasing the frequency of outputting the Vsync signal, thereby reducing power consumption waste of the device caused by frequently increasing and decreasing the frequency of outputting the Vsync signal.

In some embodiments, an embodiment of this application provides an electronic device. The electronic device has a function of implementing the image display method according to the foregoing embodiments. The function may be implemented by using hardware or may be implemented by hardware by executing corresponding software. The hardware or software includes one or more modules corresponding to the foregoing function.

In some embodiments, an embodiment of this application provides an electronic device, including a processor and a memory. The memory is configured to store computer program code. The computer program code includes computer-executable instructions. When the electronic device runs, the processor executes the computer-executable instructions, to cause the electronic device to perform the image display method according to the foregoing embodiments.

In some embodiments, an embodiment of this application provides an electronic device, including a processor. The processor is configured to be coupled to a memory, read instructions from the memory, and perform the image display method according to the foregoing embodiments based on the instructions.

In some embodiments, an embodiment of this application provides a computer-readable storage medium including computer instructions. The computer instructions, when run on an electronic device, cause the electronic device to perform the wallpaper display method described above.

In some embodiments, an embodiment of this application provides a computer program product. The computer program product, when run on an electronic device, cause the electronic device to perform the image display method according to the foregoing embodiments.

In some embodiments, an embodiment of this application provides a computer program product including instructions. The instructions, when run on a computer, cause the computer to perform the image display method according to the foregoing embodiments.

In some embodiments, an embodiment of this application provides an apparatus (for example, the apparatus may be a display system). The apparatus includes a processor, configured to support an electronic device in implementing a function of the image display method according to the foregoing embodiments. In a possible design, the apparatus further includes a memory. The memory is configured to store program instructions and data that are necessary for the electronic device.

Through the descriptions of the above implementations, a person skilled in the art may clearly understand that, for convenient and brief description, only division of the above functional modules is illustrated. In actual application, the above functions may be allocated to and completed by different functional modules based on requirements. That is, an inner structure of an apparatus is divided into different functional modules, so as to complete all or some of the functions described above.

In the several embodiments provided in this application, it should be understood that the disclosed apparatus and method may be implemented in other manners. For example, the described apparatus embodiments are merely examples. For example, the division of the modules or units is merely logical function division, and may be other division during actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms. The units described as separate parts may or may not be physically separated. Parts displayed as units may be one physical unit or a plurality of physical units, that is, may be located at one position, or may be distributed to different positions. Some or all of the units may be selected depending on actual requirements to achieve the objectives of the solutions in embodiments.

In addition, the functional units in embodiments of this application may be integrated into one processing unit, or each of the units may exist alone physically, or two or more units may be integrated into one unit. The integrated unit may be implemented in a form of hardware, or may be implemented in a form of a software functional unit. When the integrated unit is implemented in the form of a software functional unit and is sold or used as an independent product, the integrated unit may be stored in a readable storage medium. Based on such an understanding, the technical solutions of embodiments of this application essentially, or the part contributing to the related art, or all or some of the technical solutions may be implemented in a form of a software product. The software product is stored in a storage medium and includes several instructions for instructing a device (which may be a single-chip microcomputer, a chip, or the like) or a processor (processor) to perform all or some of the steps of the methods described in embodiments of this application. The foregoing storage medium includes: any medium that can store program code, such as a USB flash drive, a removable hard disk, a read only memory (read only memory, ROM), a random access memory (random access memory, RAM), a magnetic disk, or an optical disc.

The foregoing content is only specific implementations of this application, but is not intended to limit the protection scope of this application. Any variation or replacement within the technical scope disclosed in this application shall fall within the protection scope of this application. Therefore, the protection scope of this application should be subject to the protection scope of the claims.

What is claimed is:

1. An image display method, applied to an electronic device, wherein the electronic device comprises a display screen, and the method comprises:
generating, by the electronic device, a first Vsync signal at a first time, and displaying, by the display screen, a first image in response to the first Vsync signal, wherein the first Vsync signal corresponds to a first Vsync periodicity, the first Vsync periodicity corresponds to a first display duration, and the first display duration is a display duration of the first image;
generating, by the electronic device, a second Vsync signal at a second time, and displaying, by the display screen, a second image in response to the second Vsync signal, wherein the second Vsync signal corresponds to a second Vsync periodicity, the second Vsync periodicity is equal to the first Vsync periodicity, and the second time is after the first time; and
generating, by the electronic device, a third Vsync signal at a third time in response to a second display duration being greater than the first display duration, wherein the third Vsync signal corresponds to a third Vsync periodicity, the second display duration is a display duration of the second image, the third time is after the second time, and the third Vsync periodicity is less than the first Vsync periodicity.

2. The method according to claim 1, wherein the second image is a next frame of image of the first image.

3. The method according to claim 2, wherein the second display duration is less than twice the first display duration.

4. The method according to claim 1, wherein the method further comprises:
displaying, by the display screen, a third image in response to the third Vsync signal, wherein the third image is a next frame of image of the second image.

5. The method according to claim 4, wherein a third display duration is less than the first display duration, and the third display duration is a display duration of the third image.

6. The method according to claim 4, wherein a third display duration is the same as the first display duration, and the third display duration is a display duration of the third image.

7. The method according to claim 4, wherein the method further comprises:
generating, by the electronic device, a fourth Vsync signal at a fourth time, wherein the fourth time is after the second time and before the third time.

8. The method according to claim 7, wherein the method further comprises:
continuing to display, by the display screen, the second image in response to the fourth Vsync signal.

9. The method according to claim 1, wherein the first Vsync periodicity is 8.3 ms, and the third Vsync periodicity is 2.8 ms.

10. The method according to claim 1, wherein the first display duration is 8.3 ms, and the second display duration is 11.1 ms.

11. The method according to claim 1, wherein the method further comprises:
generating, by the electronic device, a fifth Vsync signal at a fifth time, wherein the fifth Vsync signal corresponds to a fifth Vsync periodicity, the fifth time is after the third time, and the fifth Vsync periodicity is equal to the first Vsync periodicity.

12. The method according to claim 11, wherein a display duration of a fourth image is greater than a preset time interval; and the fourth image is an image displayed in the previous frame of the fifth time, the preset time interval is obtained by subtracting a duration consumed for reducing a frequency of outputting a Vsync signal from a time interval between the fifth time and a sixth time, and the sixth time is a time at which the fourth image is written to the display screen.

13. The method according to claim 11, wherein the fifth time is N times 8.3 ms apart from the third time, wherein N is a positive integer greater than or equal to 1.

14. The method according to claim 1, wherein the electronic device further comprises an image display driver; and the method further comprises:
calculating, by the image display driver, the second display duration in response to the display screen displaying the second image; and
sending, by the image display driver, a control instruction to the display screen in response to the second display duration being greater than the first display duration, and generating, by the display screen, the third Vsync signal.

15. An electronic device, wherein the electronic device comprises: a processor and a memory, wherein the processor is coupled to the memory; and the memory is configured to store computer program code, wherein the computer program code comprises computer instructions, and the processor, when executing the computer instructions, the electronic device is enabled to perform:
generating, by the electronic device, a first Vsync signal at a first time, and displaying, by a display screen of the electronic device, a first image in response to the first Vsync signal, wherein the first Vsync signal corresponds to a first Vsync periodicity, the first Vsync periodicity corresponds to a first display duration, and the first display duration is a display duration of the first image;
generating, by the electronic device, a second Vsync signal at a second time, and displaying, by the display screen, a second image in response to the second Vsync signal, wherein the second Vsync signal corresponds to a second Vsync periodicity, the second Vsync periodicity is equal to the first Vsync periodicity, and the second time is after the first time; and
generating, by the electronic device, a third Vsync signal at a third time in response to a second display duration being greater than the first display duration, wherein the third Vsync signal corresponds to a third Vsync periodicity, the second display duration is a display duration of the second image, the third time is after the second time, and the third Vsync periodicity is less than the first Vsync periodicity.

16. The electronic device according to claim 15, wherein the second image is a next frame of image of the first image.

17. The electronic device according to claim 16, wherein the second display duration is less than twice the first display duration.

18. The electronic device according to claim 15, wherein the electronic device is further enabled to perform:
displaying, by the display screen, a third image in response to the third Vsync signal, wherein the third image is a next frame of image of the second image.

19. The electronic device according to claim 18, wherein a third display duration is less than the first display duration, and the third display duration is a display duration of the third image.

20. A computer-readable storage medium, wherein the computer-readable storage medium comprises computer instructions, and the computer instructions, when run on an electronic device, the electronic device is enabled to perform:
generating, by the electronic device, a first Vsync signal at a first time, and displaying, by a display screen of the electronic device, a first image in response to the first Vsync signal, wherein the first Vsync signal corresponds to a first Vsync periodicity, the first Vsync periodicity corresponds to a first display duration, and the first display duration is a display duration of the first image;
generating, by the electronic device, a second Vsync signal at a second time, and displaying, by the display screen, a second image in response to the second Vsync signal, wherein the second Vsync signal corresponds to a second Vsync periodicity, the second Vsync periodicity is equal to the first Vsync periodicity, and the second time is after the first time; and
generating, by the electronic device, a third Vsync signal at a third time in response to a second display duration being greater than the first display duration, wherein the third Vsync signal corresponds to a third Vsync periodicity, the second display duration is a display duration of the second image, the third time is after the second time, and the third Vsync periodicity is less than the first Vsync periodicity.
